(19) United States
(12) Patent Application Publication
(10) Pub. No.: US 2002/0138317 A1
(43) Pub. Date: Sep. 26, 2002

(54) System for implementing an exchange

(75) Inventors: Steven Siong Cheak Mok, Singapore (SG); Yew Hing Chong, Singapore (SG); Soon Teong Poh, Singapore (SG)

Correspondence Address: IPSOLON LLP, 805 SW BROADWAY, #2740, PORTLAND, OR, 97205, US

(73) Assignee: Milling Systems and Concepts Pte Ltd., SG (SG)

(21) Appl. No.: 09/974,258

(22) Filed: Oct. 9, 2001

Related U.S. Application Data
(60) Provisional application No. 60/277,741, filed on Mar. 21, 2001.

(51) Int. Cl. G06F 17/60

(52) U.S. Cl. 705/7; 705/1

(57) ABSTRACT

An Internet-based exchange management system for implementing a manufacturing task requested by a user of an exchange, the system comprising: a project management processing system operable to provide a visual representation of the progress of the task to the user; a resource management processing system, operable to maintain a record of software which the exchange is licensed to utilise; a monitoring processing system, operable to monitor the operational status of at least one manufacturing facility involved in the manufacturing task; and a collaboration processing system, operable to allow real-time collaboration between the user and other members of the exchange.

THIS INVENTION relates to a system for implementing an exchange between an entity specifying a task, particularly a manufacturing task that the entity wishes to be carried out, and a plurality of facilities which may be capable of carrying out the task.

### BACKGROUND TO THE INVENTION

The commerce company HAHT (www.haht.com) categorises business to business (B2B) exchanges into four different types of business relationship systems, namely private extranets, private exchanges, public exchanges and consortium-based exchanges.

A private extranet provides a data processing system (which may or may not be web-based) for a collection of most trusted supplier/customer partnerships. Such a system is developed to improve efficiency and communication in the strategic processes of the partners who subscribe to the private extranet. Since participation in a private extranet is restricted to a very small numbers of partners, the partners can invest in specialised technology to optimise the flow of information, transactions, products and services between one another. This is an example of a one-to-one or one-to-few model, and provide extranets typically exist between established companies and their in-house vendors.

A private exchange provides a web-based data processing system, which suppliers use by embedding the system in their e-commerce website to create a market for their products, to provide buying and servicing experience for existing customers, and also to engage new customers. Potential buyers use a private exchange to engage and compare suppliers, in order to optimise their buying resources. This is an example of a one-to-many model, and examples of private exchanges include Internet banking portals, Internet brokerages and regional dealers' e-commerce websites.

Public exchanges, also known as horizontal exchanges, provide web-based data processing systems for commerce for virtually and kind of participant, product or service. Such systems may allow excess inventory sales, focus on a particular buying and selling community, focus on a particular set of products, or simply provide electronic open auction mechanisms. This is an example of a many-to-many model, which is followed by many on-line classified systems, on-line-auctions and on-line cataloguing systems.

Finally, consortium-based exchanges provide a tightly coupled web-based data processing system for vertical industries. Such exchanges are motivated by the leading buyers in the market, but are usually supported by suppliers, and ideally offer a win-win scenario for all parties involved. The terms, conditions, transaction definitions, and other elements of commerce in a vertical exchange are tuned to reflect the particular practices of the vertical market in question, and most participants are likely to benefit from the resulting increase in market efficiency. This is an example of a some-to-some model, and many automotive portals, petrochemical portals, medical portals and health care portals operate on this basis.

Consortium-based exchanges display the benefits of their unique approaches to bringing together buyers and sellers of “custom” and “made to order” parts when large companies attempt to condense and streamline their laborious supply chains. Additionally, many large companies use on-line auctions to bring down suppliers' prices as much as possible.

Existing consortium-based B2B exchanges believe that large companies will have to focus on quality, responsiveness, and delivery to meet the demands of future business environments. However, there is more to consider in this respect than simply the price of commodities. Internet auction models may sometimes be effective for acquisition of basic commodities, but they are not viewed as a long-term solution for responsible businesses.

Existing B2B exchanges claim to be global member networks that bring companies together based on their unique manufacturing processes, rather than upon the basis of simple products, catalogues, and keyword searches. Ideally, with such exchanges, a member company can find pre-qualified business partners globally, with one simple click or via a similarly short and efficient process.

When a company decides to join a typical B2B exchange, they log on to the web site of the exchange and fill out a comprehensive questionnaire, which is likely to be a substantially time-consuming task. The information required for the questionnaire typically includes details about the company, for instance their engineering and processing capabilities, manufacturing methods, materials used, quality certifications and so on, and may also include information regarding the prospective member company's web site. This information is then verified by the staff of the exchange, or by world-wide affiliated representatives, and is then documented into a data server.

Subsequently, the B2B exchange creates a community identifier for the particular company, which is similar to a company's fingerprint or DNA. During a RFQ (Request for Quotation) transaction, the exchange automatically matches a list of potential sellers of “custom” and “made to order parts” to the potential buyer that makes the RFQ, on the basis of the community identifiers that have been allocated to the potential sellers.

Generally, the added value of a manufacturing B2B exchange as described above arises from the provision of accurate access to companies that provide, for example, tooling, moulds, dies, castings, grinding, heat-treating, extrusions and metal forming processes. Such an exchange is likely to help to establish the buyer's connections or links with manufacturers and vendors of materials, machine tools, equipment, packaging, shipping and import/export, financing and so forth.

After bringing relevant buyers and manufacturers or suppliers of all sizes together to do business with one another in a single web-based business environment, some consortium-based exchanges place particular emphasis on making information accessible and visible within a secure online environment. Ideally, information is secure within such an exchange, and the owner of the information retains control over who may see and access the information.

Also, a great deal of time and attention has been invested in enabling companies to compress planning cycles and enhance supply chain planning through an exchange by providing collaboration between companies, visibility of processes, and integration of companies' various systems.

By addressing many functional needs across the entire life cycle of a product in any one of various industries, these B2B exchanges start to concentrate primarily on the development of collaboration; procurement; the supply chain; and quality, each of which will be discussed below in more detail.

Collaboration: in the modern environment of outsourced product design and compressed product life cycles, suppliers' (i.e. outsourced-manufactures') roles have been transformed. For instance, such suppliers receive more responsibility to engineer and manufacture systems and components than has previously been the case. As supplier's roles change, the sourcing process increases in complexity and the supplier selection process intensifies. Inefficient data exchange between suppliers creates friction that lengthens development times, increases design costs, and lengthens the entire sourcing process. Consequently, an effective collaboration solution is sought by many to facilitate communications particularly across corporate and enterprise boundaries. Such a collaboration tool, which forms part of many exchanges, is commonly known as a “Virtual Project Workspace” or a “Virtual Office”.

Procurement: Companies have begun to harness the power of the Internet to transform the role of procurement from an administrative to a strategic role. By using an exchange to automate such traditionally “paper-intensive” activities as purchasing processes, procurement professionals can focus on value-added tasks, such as developing procurement strategies and improving the performance of suppliers.

Such an exchange seeks to provide a global market place, in which industry participants can buy and sell a wide range of products and services. An ideal exchange should support each company's unique procurement processes, while integrating multiple systems with one another to allow a seller to communicate with many different buyers.

Besides implementing some common public exchange tools, such as auctions, reverse auctions and catalogues, some consortium-based exchanges have developed their electronic document management, analysis and collaboration processing systems in order to provide a tool that supports the entire sourcing process. Such a tool should provide a central, online repository of sourcing documentation, which documentation can easily be posted, viewed, edited and downloaded by authorised users through a simple Web browser. Users of such a tool would include purchasing, engineering and design representatives from both buying and selling organisations.

The common procurement functions of an electronic document management, analysis and collaboration processing system include: the conducting of Teal-time, online supplier reviews; the electronic gathering of all RFQ documents in a central online repository; the creation of RFQ's using a template; the sending of notifications to suppliers that an RFQ is electronically available for review; tie automatic tracking of revisions in documents via electronic version control; the receiving and comparing of templated electronic responses; the electronic storage of RFQ's and their responses for the maintenance of a historical record; and the tracking and management of communications, including schedules, supplier contacts, 2- and 3-D drawings, specifications and RFQ's and their responses.

An efficient procurement system enables the acquisition and disposition of assets through a virtual asset marketplace. Another function of a procurement system may be an asset recovery system, which enables management and disposal of internal assets.

Supply Chain: it is believed that enabling inventory visibility and information flow between trading partners or suppliers improves the ability of the partners or suppliers to perform effective inventory management. Consortium-based exchanges help to save time and money by reducing excessive inventory, and this reduction comprises a major step towards the realisation of a “build-to-order” era.

An Internet enabled material fulfilment service of an exchange allows the rapid sharing of information, such as inventory levels, usage history and patterns, forecasts, in-transit inventories, receipts and other relevant information. This sharing of information helps to eliminate excess inventory, as well as premium transportation charges. Since all of the relevant information is available in one electronically maintained location, this service eliminates the need for a partner or supplier to search multiple databases, paper files, faxes, e-mail messages and so forth in order to manage supply chain execution events effectively.

A real time material fulfilment service ideally provides a monitoring tool which monitors actual consumption of resources and inventory levels, so that one is able to respond quickly and efficiently to any changes in these parameters. With presently available technology, one can receive and transmit information regarding resource consumption and inventory levels using self-specified formats and protocols with a simple web-browser.

In addition, a real time material fulfilment service should enable productivity by providing suppliers with information relating to: inventory levels; min/max output levels; electronic “kanban” systems; in-transit inventory; usage rates and trends; last received shipments; and supplier ratings on a function-rich database.

Other possible functions that may be provided include the ability to share shipping plans with logistics providers, and the ability to generate and transmit advance shipping notices (ASN's) for customers.

To implement a supply relationship management system, a consortium-based exchange may offer the sharing of critical information between members of the exchange, such as material releases, production schedules and shipping notices. Since all suppliers will connect to such an exchange through a single integration point, this facility may potentially eliminate the reed for the multiple point-to-point communications that suppliers are currently required to establish and maintain to gather such information.

Presently, many existing B2B exchanges are able to communicate suppliers using varied formats such as EDI, XML, flat files and spreadsheets to send and receive documents such material releases, production and shipping schedules, advance shipping notices, purchase orders, acknowledgements, amendments and many other types of document.

One may integrate a back-end system with the exchange, or simply direct a browser to the exchange portal to upload and download relevant files.

All documents and data received by such an exchange are typically translated into a standard version of XML. Maps, translating data into XML documents, are maintained within the exchange and employed to facilitate direct communications between suppliers.

Quality: typically, for every problem identified in an assembly plant, a manufacturer issues a problem report. Industry experience shows that, in a typical assembly plant, anywhere from 15-50 problem reports may be issued daily. Extrapolating those numbers globally, it is expected that 3.2 million problem reports per year may be issued within a particular industry. Currently, the response to each report must be in format specified by the manufacturer in question. Consequently, a supplier is likely to invest a significant amount of time and energy in the administrative tasks involved in answering problem reports. Clearly, this time could be more productively spent in preventative quality planning, to avoid the occurrence of such problems in the future.

A consortium-based exchange may provide customers and suppliers subscribing thereto with a tool comprising an Internet based means to communicate problems, and prompt proper permanent corrective action plans, from one central, individually secure, hosted location. Such a tool ideally provides an industry standard methodology for responding to problem reports. Because such tools are usually based on XML formatting, each manufacturer can view the responses in their respective specific company formats.

Before the introduction of such exchanges, suppliers spent extensive resources in the management of the product quality planning process, which comprises locating and accessing quality information, meeting milestones, achieving approval, and producing high quality parts.

It is claimed that implementing such a process in an Internet-based environment helps to create more robust, problem-free designs, and minimises the probability of products having quality defects reaching a customer, thereby reducing non-value-added tasks associated with managing and exchanging documentation and providing real-time access to mission-critical information.

In a general RFQ transaction, buyers are likely to rate sellers on their price, quality, delivery time and responsiveness. Suppliers, on the other hand, are likely to rate buyers on payment time and responsiveness. A B2B exchange usually purports to be positioned as a neutral party, which may provide a sophisticated rating system for both buyers and sellers. Theoretically, an ideal B2B exchange should be able to guarantee the quality of suppliers to potential buyers while at the same time assuring the suppliers of business from the potential buyers.

Unfortunately, in practice, it is found that conventional B2B exchanges fail to be genuinely neutral parties between buyers and suppliers. This is because, in most conventional B2B exchanges, suppliers contribute a major portion of the income of the B2B exchange. Therefore, a buyer's interest is likely not to be completely protected, particularly in the event of a conflict between the buyer and a supplier.

Also, conventional B2B exchanges fail to be genuinely neutral parties among suppliers because small or medium manufacturers will, in general, always have lower qualifications or ratings, and are unlikely to be able to afford to offer prices as low as those offered by larger or more established suppliers. From a conventional B2B exchange, a small or medium company is likely only to gain some RFQ bidding experience.

Effectively, buyers demand a high quality of end product, rather than a compilation of certified suppliers, as offered by the Internet based data processing system of conventional exchanges. For instance, a certified supplier may have supplied a lower grade or expired material due to an inexpensive quote to which the supplier committed therefore, buyers ultimately bear their own risk when confirming an order. A zealous company may offer the lowest price, at the last possible moment, by committing to a long-term contract with one simple click.

Conventional Internet-based data processing systems face difficulties in verifying the credentials of subscribing suppliers. For instance, a main certified supplier might obtain resources from several small suppliers, which in turn might come from different countries which have different qualification and quantity requirements. In a worst-case scenario, a main supplier might act as a middleman (“loaning” its brand names to small suppliers) in a RFQ process. Consequently, a buyer in the B2B exchange is likely to obtain a “reasonable” quote and a “mark-up” quote from these suppliers.

It is found that the existing consortium-based exchanges implement their Internet-enabled collaborative, procurement, supply chain and quality systems with traditional management systems, such as supply chain management, enterprise resource planning, material resource planning, and so forth. These traditional management systems are simply upgraded from extranet-enabled infrastructures to Internet-enabled infrastructures.

Unfortunately, the efficiency or productivity of such traditional management systems in an exchange environment are predictably low. This is because, as compared to an ordinary in-house supplier, a typical supplier in an exchange is likely to have a unique supplier identity. This identity may be defined by the relationship between the supplier and a particular buyer, (for instance exchange owned companies, multiple tiers of suppliers, strategic partners, etc.), geographical location, core competitive advantage (i.e. the manufacturing capabilities of the supplier), the targeted industrial applications of the supplier, and the culture, government policy and so forth prevailing in the location of the supplier.

More specifically, each project engineer associated with an entity that is a member of an exchange is likely to have his own interpretation of “project progress”. Project Progress is, indeed, very difficult to quantify. However, throughout a product development process, most tasks require quality checks, verification, audit or approval for the execution of subsequent tasks. Such measures are themselves likely to involve various quality standards.

Traditional systems rigidly employ a particular platform to synchronise the interpretation of “project progress” among all of the project engineers involved with an exchange. However, individual project engineers must use their initiative to submit relatively accurate project progress updates to authorised leaders.

Traditional management systems generally provide resource management tools. “Resources” in the traditional sense may include manufacturing machines, manufacturing systems, designs and engineering desktops, staff, equipment, material stocks, and so on. In any traditional system, proper and effective measurement of the usage of these resources proves to be almost impossible.

For instance, most existing manufacturing machines and systems are managed by their dedicated closed-loop controllers. Likewise, design and engineering desktops arc operated on their individual robust platforms or operating systems, such as UNIX or DOS.

Existing exchanges typically offer collaboration solutions, which aim to facilitate communication across corporate and enterprise boundaries. Currently, some general tools are implemented in real-time, and these include video conferencing tools, on-line message boards and collaborative design tools. However, not all such tools are implemented in real-time, and consequently additional effort is required to study in real-time the implementation of an entire process flow which is being earned out through an exchange. Such a study should include stages of a process such as the design, engineering, manufacturing, warehousing, logistics, insurance and financing of a manufacturing solution, and clearly the ability to effectively obtain information on these stages would be of great benefit.

In the manufacturing industry, existing web-based real-time monitoring and feedback systems are mostly employed for the maintenance and diagnostic and technical support of a manufacturing control system. Such maintenance and support may include emergency support, critical service support, routine technical support, on-line training, critical spare parts ordering, software and control upgrades, and repair and test services.

On the other hand, in a manufacturing process conducted through a consortium-based exchange, a manufacturing facility is only as strong as the weakest link. Fault times, starved times, excessive set-up and/or change over times, and other down times can drastically reduce the efficiency of the entire consortium.

It is believed that real-time monitoring and feedback systems would give subscribers to a consortium-based exchange the power to make well-informed decisions quickly and reliably. In addition, such monitoring would offer the statistical data required to trace process flow patterns and these patterns can be used to improve productivity.

### SUMMARY OF THE PRESENT INVENTION

To seek to alleviate the problems described above, an exchange management system is proposed. This system is able to upgrade a conventional consortium-based B2B exchange into a total integrated electronic business for a one-stop manufacturing solution.

A “total integrated electronic business” in the context of the present invention can be described as a business community, which consists of a comprehensive global network of buyers, certified suppliers and strategic partners.

A “one-stop manufacturing solution” in this context encompasses a whole spectrum of manufacturing business and supply chain management, which may be demanded by any B2B customer. This spectrum may include mechanical and/or electronic design, production and turnkey services, software and hardware customisation, trading of industrial products, remote software services, resource sharing, maintenance and support, insurance, financing hire, purchase, leasing and end-product delivery.

Customers of the exchange may include a solution buyer, an end-user, a licensee, a “pay-as-you-go” member, a “flat fee” member, a web-based process-line, a system or a machine.

The present invention provides an exchange management system, which places particular emphasis on: project management; resource management; real-time monitoring and feedback; and collaboration; each of which will be discussed in relation to the present invention in greater detail below. The management system seeks to optimise the flow of information, transactions, products and services between members of die community.

The management system of the present invention provides a project management processing system, which provides “visual” project progress status.

Advantageous features of the project management processing system include the electronic publishing of designs; engineering results; manufacturing images; manufacturing process line images; and verifications.

The objective of the project management processing system is to provide any suitably authorised user with an accurate and reliable progress status with respect to a design engineering or manufacturing project, and this is achieved by the provision of a visual representation of the progress of the project.

In addition, the exchange management system provides a resource management processing system, which is operable to maintain a record of software which the exchange is licensed to utilise.

The resource management processing system exists to control the traffic of check-ins and check-outs of (i.e. subscription to and de-subscription from) software licenses. Objectives of the resource management processing system are to manage the capabilities and capacities of an exchange, to ensure that licenses to necessary software have been obtained, and to ensure that no licences in respect of unnecessary software are maintained.

The exchange management system of the present invention further provides a monitoring, processing system, which is operable to monitor the operational status of at least one manufacturing facility.

The monitoring processing system is concerned with real-time monitoring and feedback, and features thereof advantageously include: project schedule i.e. (queue) management; facility operations status reporting; the maintenance of a database of manufacturing facilities and their technical specifications; and statistical data tracking for the purpose of process flow pattern analysis.

It is an objective of the monitoring processing system to manage the capabilities and capacities of facilities that are involved in process conducted through the exchange.

A collaboration processing system is allocated for each project. The collaboration processing system may allow video-conferencing but may also allow collaboration in real-time and remote access into software utilised by the exchange. This software, which is preferably Windows based, may include management software (SCM, ERP, MRP, etc.), Computer-aided Design (CAD) software, Computer-aided Engineering (CAE) software, Computer-aided Manufacturing (CAM) software and controlling software for manufacturing machines.

An objective of the collaboration processing system is to provide a collaborative and/or remote project workspace for exchange users around the globe to “virtually meet” preferably and to exercise remote control over processes, thus assisting in the delivery of a manufacturing solution at high speed.

The collaboration processing system preferably allows video-conferencing, real-time collaboration and remote access into software for suitably authorised members of an exchange comprising the management system. The software may include: management software; computer-aided design software; computer-aided engineering software; computer-aided manufacturing software and controlling software for machines, systems, and manufacturing lines.

Each of these processing systems will be described below in greater detail.

Preferably, the management system of the present invention can be modularly integrated into existing data processing systems, which systems may previously have implemented traditional management systems, auctions, procurement, quality control, maintenance, support and so on.

In advantageous embodiments of the present invention, a project manager has the highest authorised desktop among the users in the supply and process chains. In an exchange comprising such a management system, Project Auditors and Management Team Members act as neutral parties to perform audits on the project manager's desktop.

In order to prioritise appropriately to allow rapid responsiveness to RFQ's, the management system preferably first distributes RFQ's into project managers' desktops, Advantageously, at least 3 hubs associated with the exchange are provided located in European, Asia Pacific, and NAFTA regions respectively. It will be appreciated that these three regions have time differences of around 8 hours with respect to one another, and so the location of hubs in this manner allows responses to RFQ's to be provided rapidly whenever they are received.

### DETAILED DESCRIPTION OF EMBODIMENTS OF THE PRESENT INVENTION

In order that the present invention may be more readily understood, embodiments thereof will now be described, with reference to the accompanying drawings, in which:

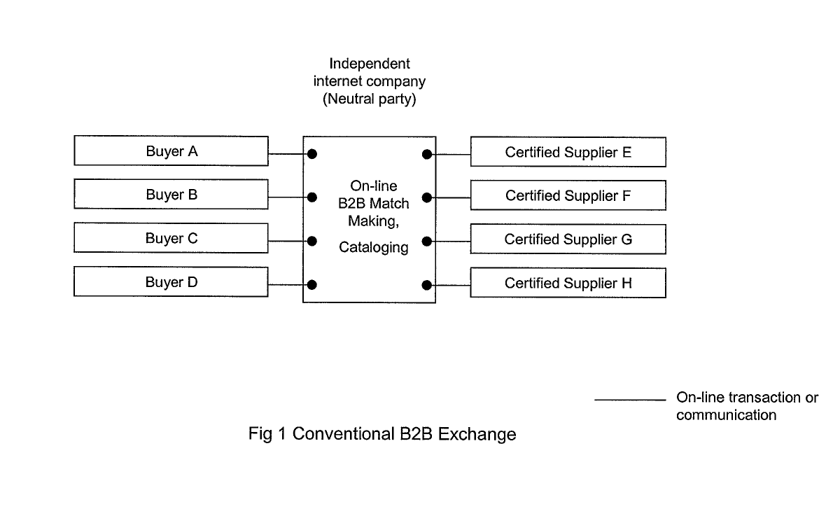

FIG. 1 is a schematic representation of a conventional B2B exchange, showing members thereof;

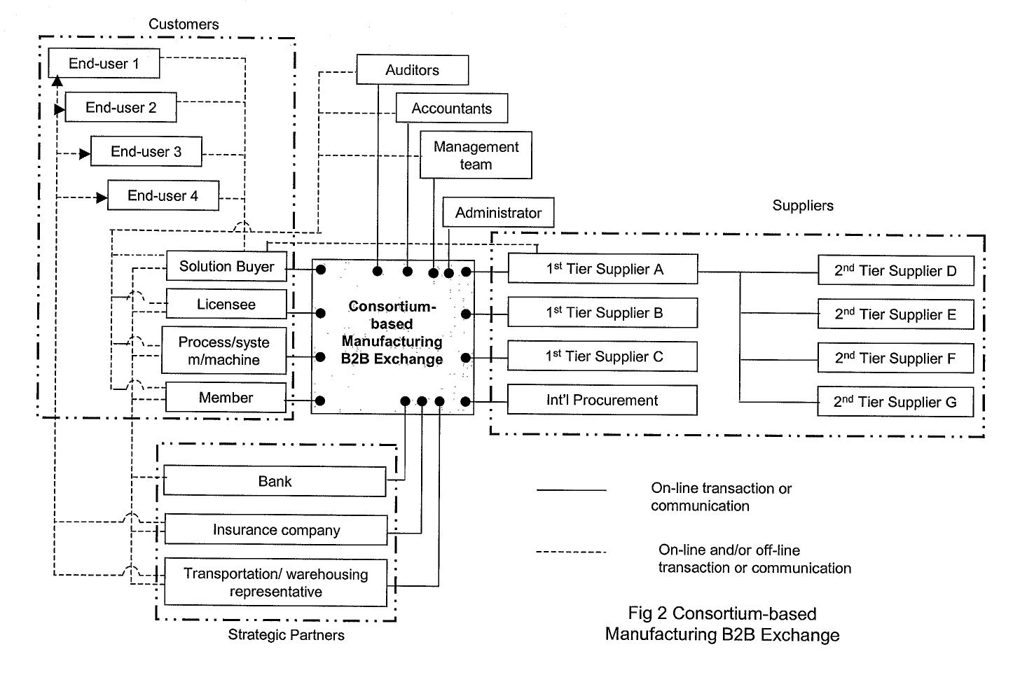

FIG. 2 is a schematic representation of a consortium-based manufacturing B2B exchange embodying the present invention, showing members thereof;

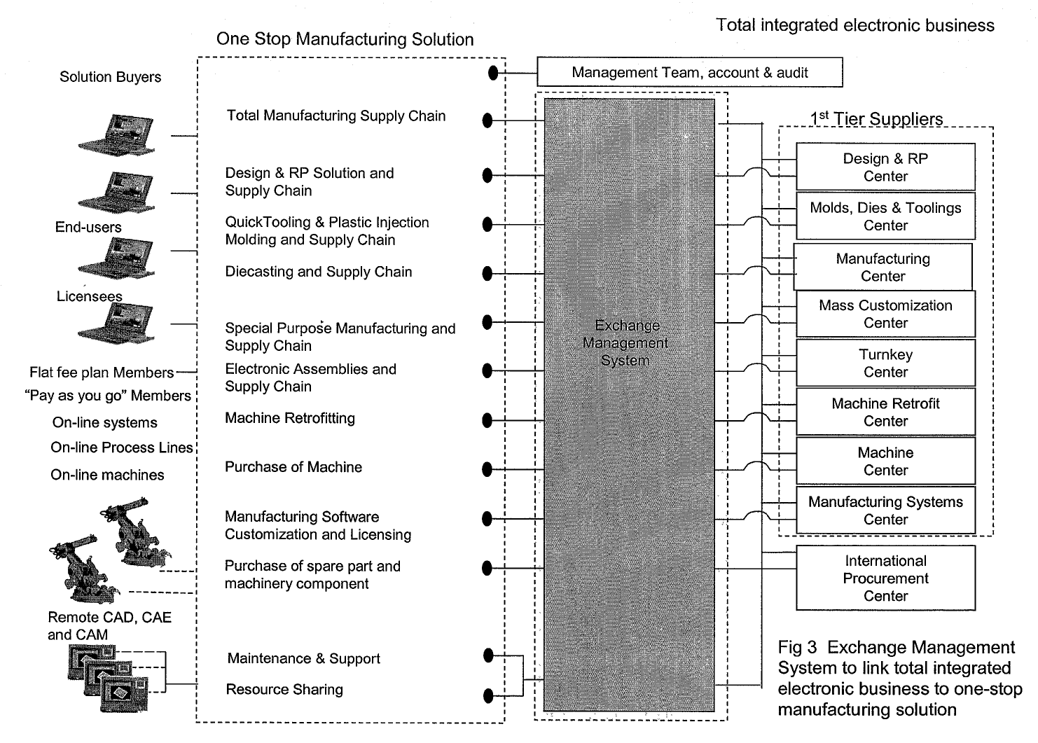

FIG. 3 is a schematic representation of an exchange management system embodying the present invention, showing links from the exchange management system to entities connected therewith;

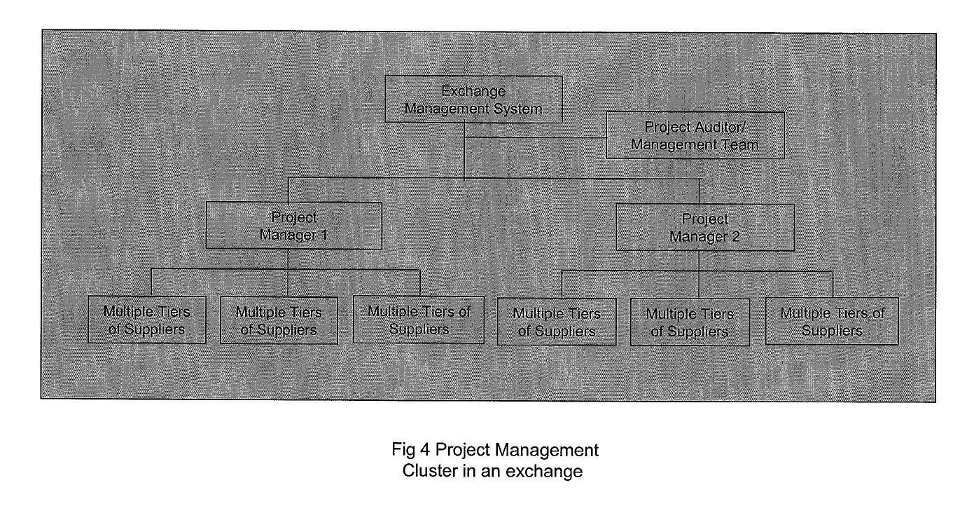

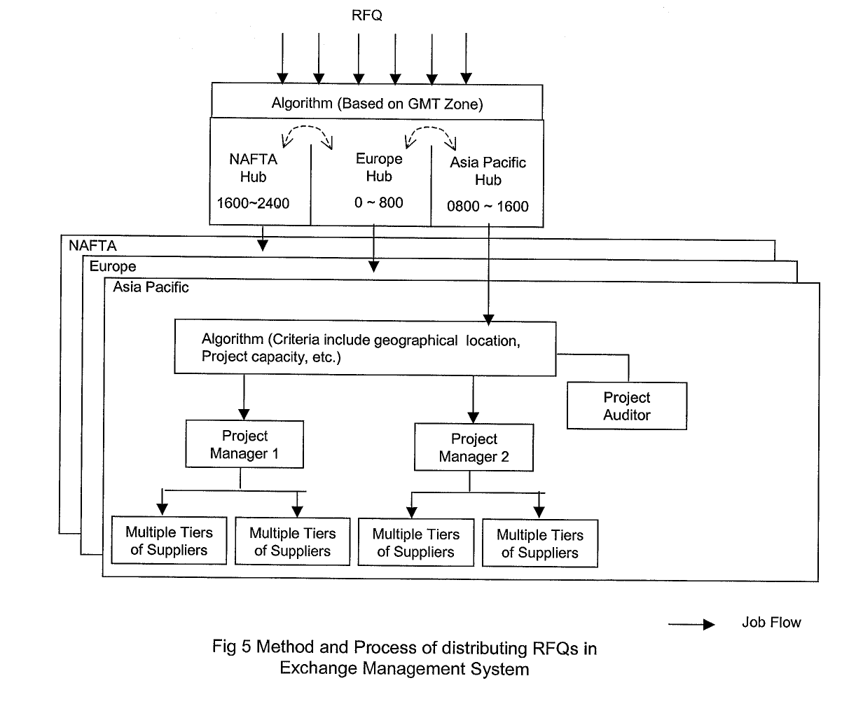

FIG. 4 is a schematic representation of a protect management cluster in an exchange embodying the present invention;

FIG. 5 shows a process flow during the distribution of RFQ's by an exchange management system embodying the present invention;

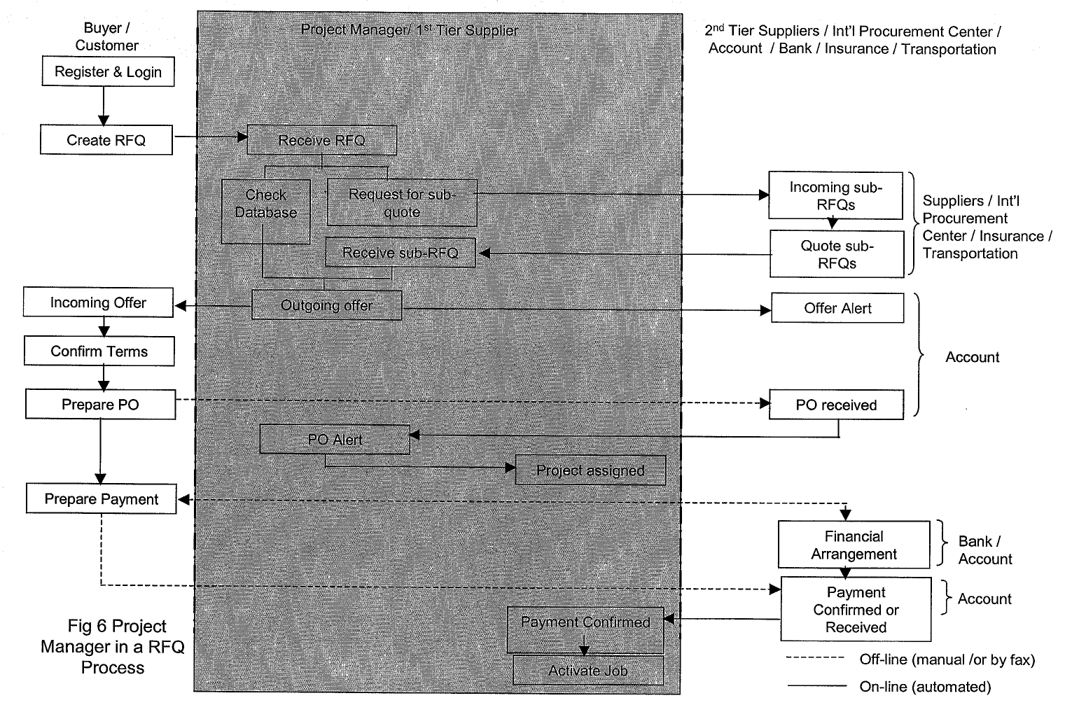

FIG. 6 is a flow diagram representing the role of a project manager or first tier supplier in an exchange embodying the present invention;

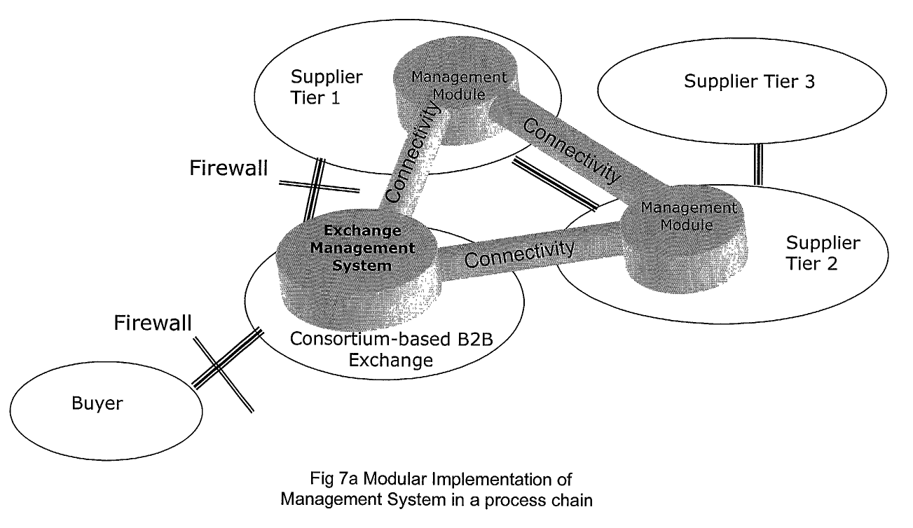

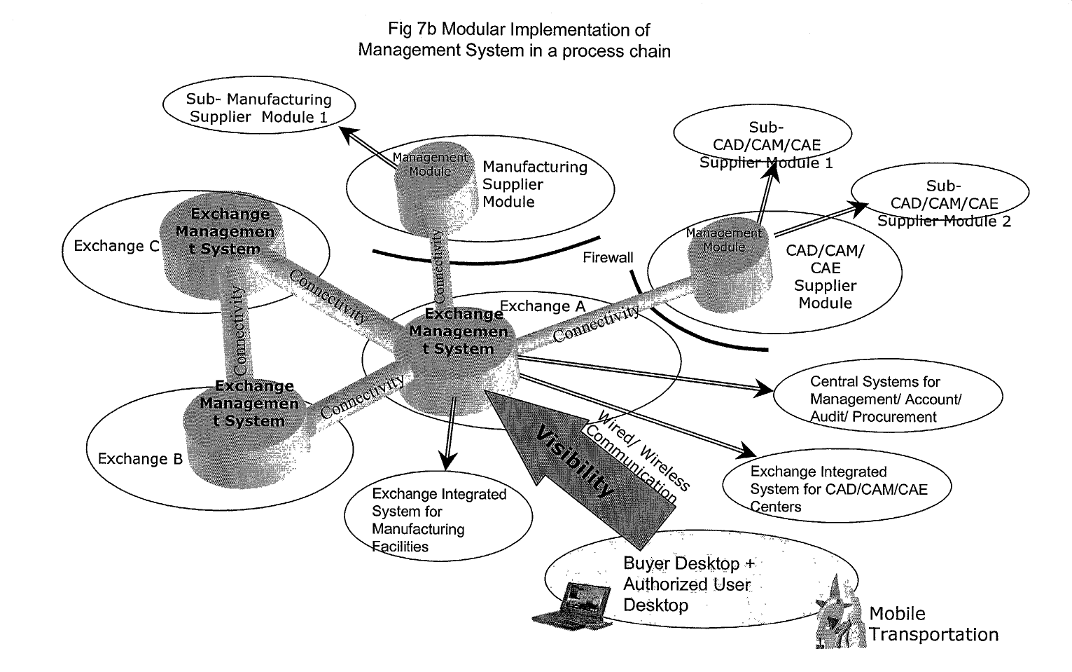

FIGS. 7a and 7b depict alternative process chains during use of an exchange management system embodying the present invention;

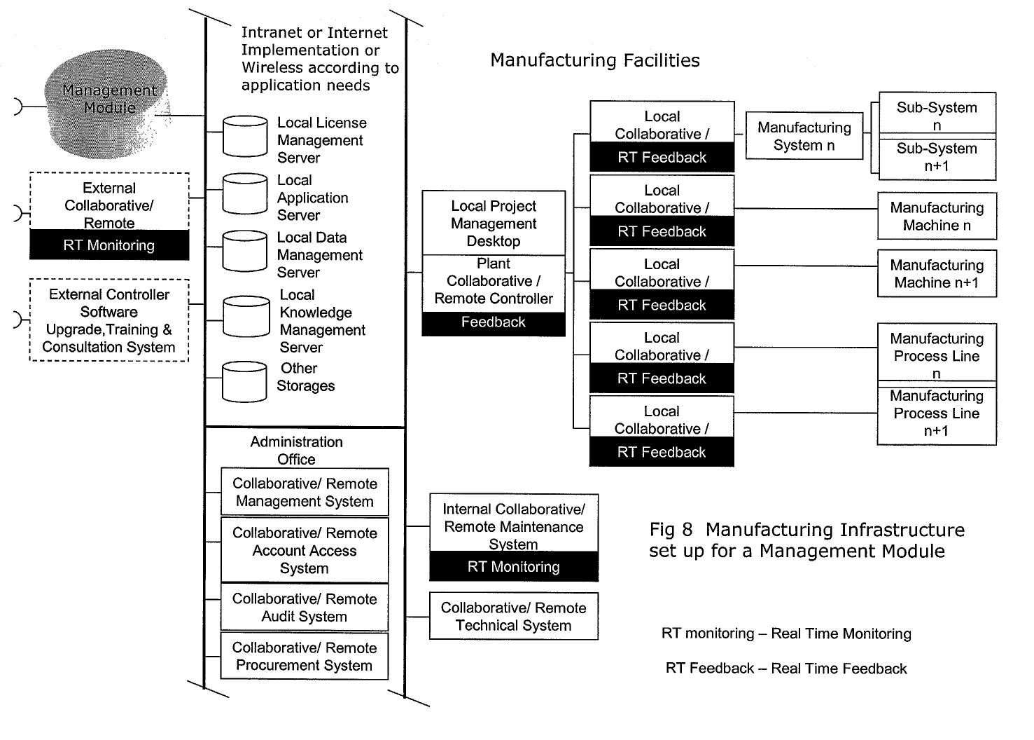

FIG. 8 is a schematic representation of a manufacturing infrastructure setup for a management module embodying the present invention;

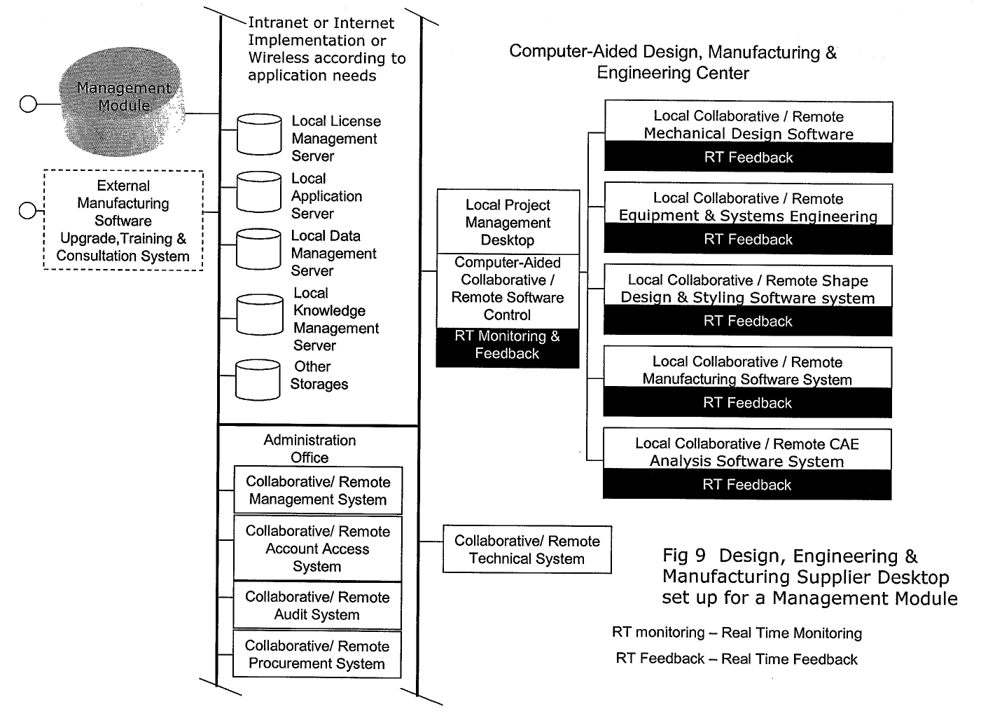

FIG. 9 is a schematic representation of a design, engineering and manufacturing supplier desktop setup for a management module embodying the present invention;

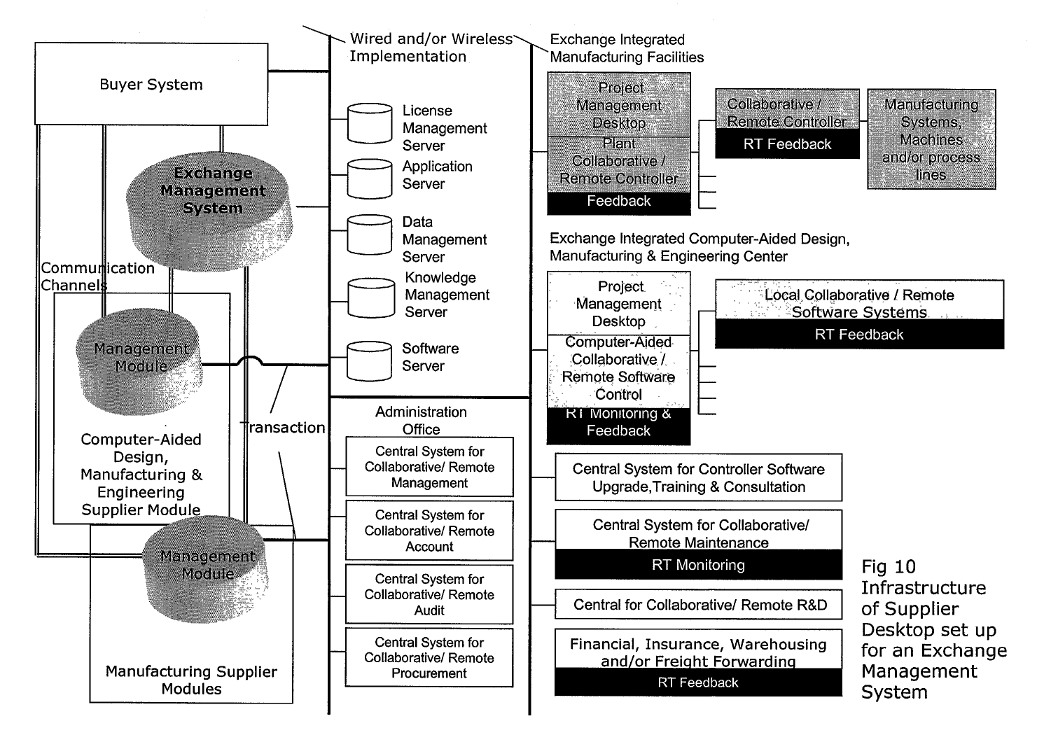

FIG. 10 is a schematic representation of an infrastructure of a supplier desktop setup for an exchange management system embodying the present invention;

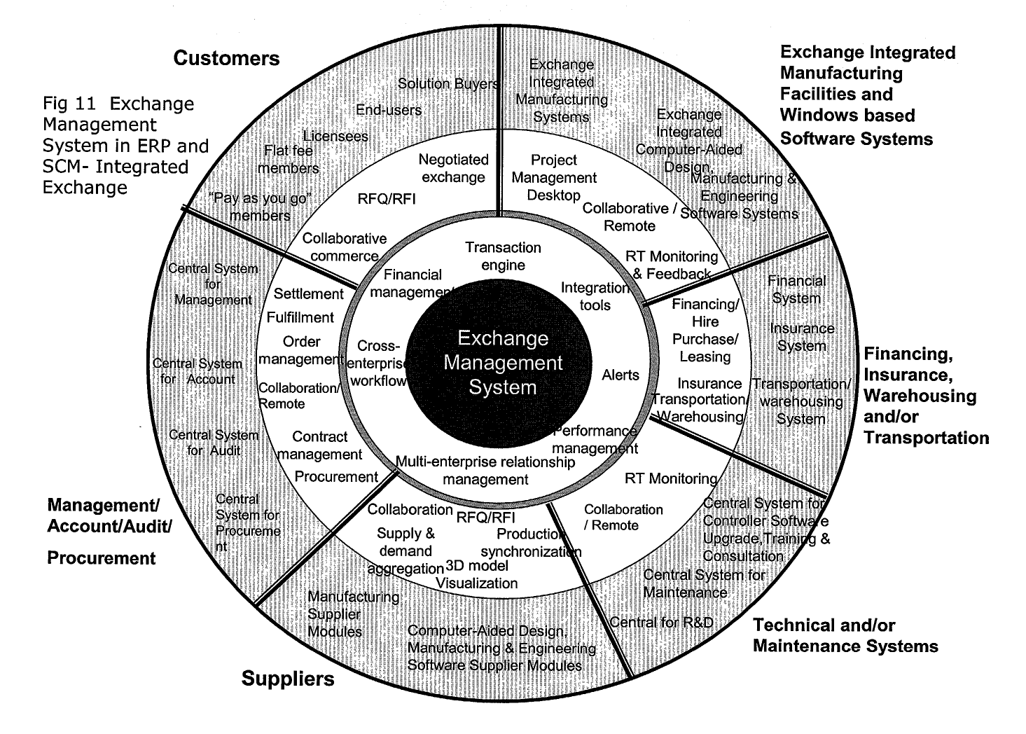

FIG. 11 shows a schematic representation of the role of an exchange management system embodying the present invention in an enterprise resource planning and supply chain management integrated exchange embodying the present invention;

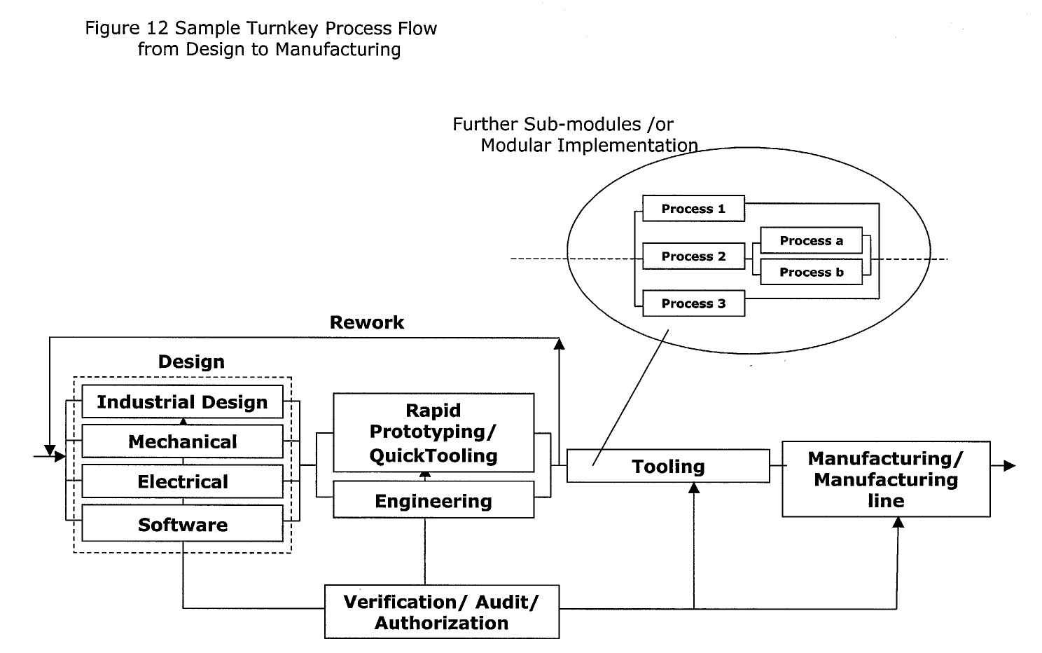

FIG. 12 shows steps in a process flow from design to manufacture of an article through an exchange embodying the present invention;

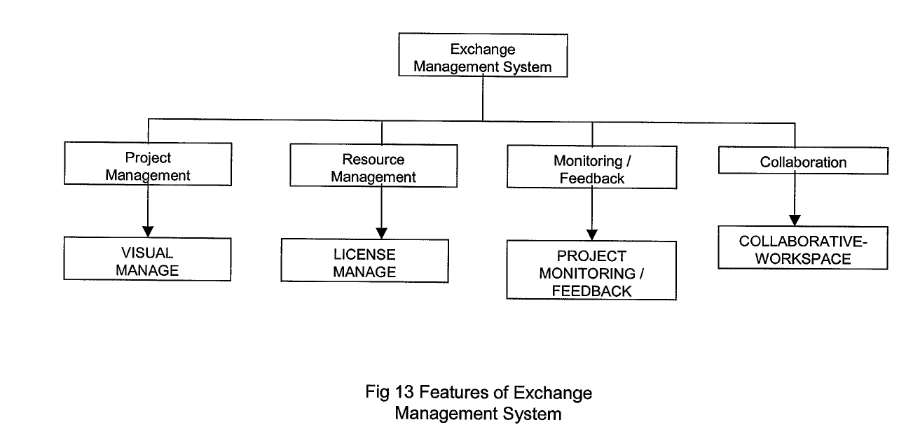

FIG. 13 is a schematic representation of elements of an exchange management system embodying the present invention;

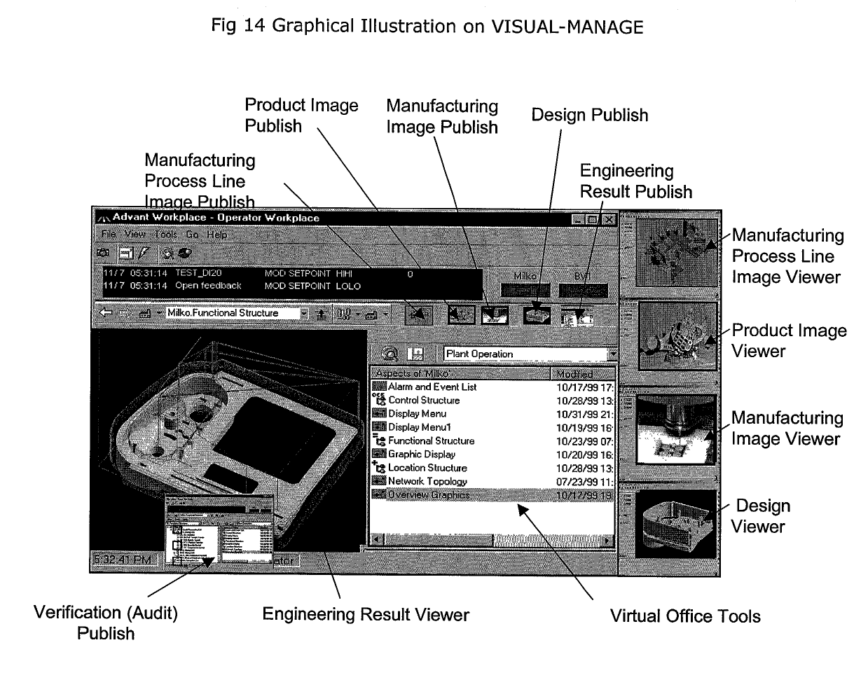

FIG. 14 shows a screen that may be seen when using a project management processing system suitable for use with the present invention;

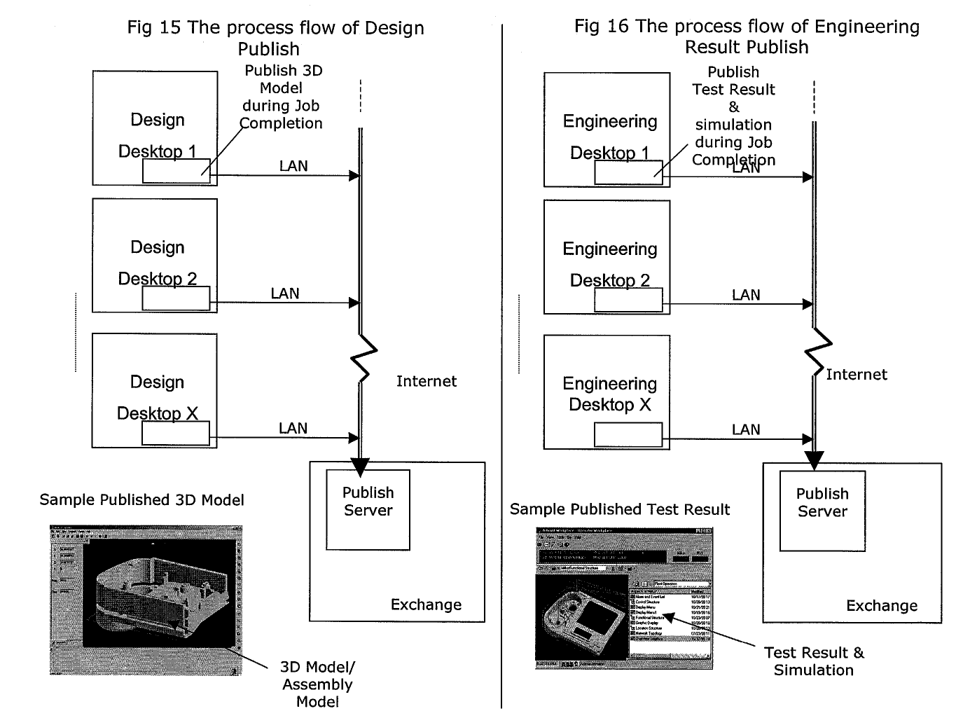

FIG. 15 shows steps in the process flow of the publishing of a design using a project management processing system suitable for use with the present invention;

FIG. 16 shows steps in the process flow of the publishing of an engineering result using a project management processing system suitable for use with the present invention;

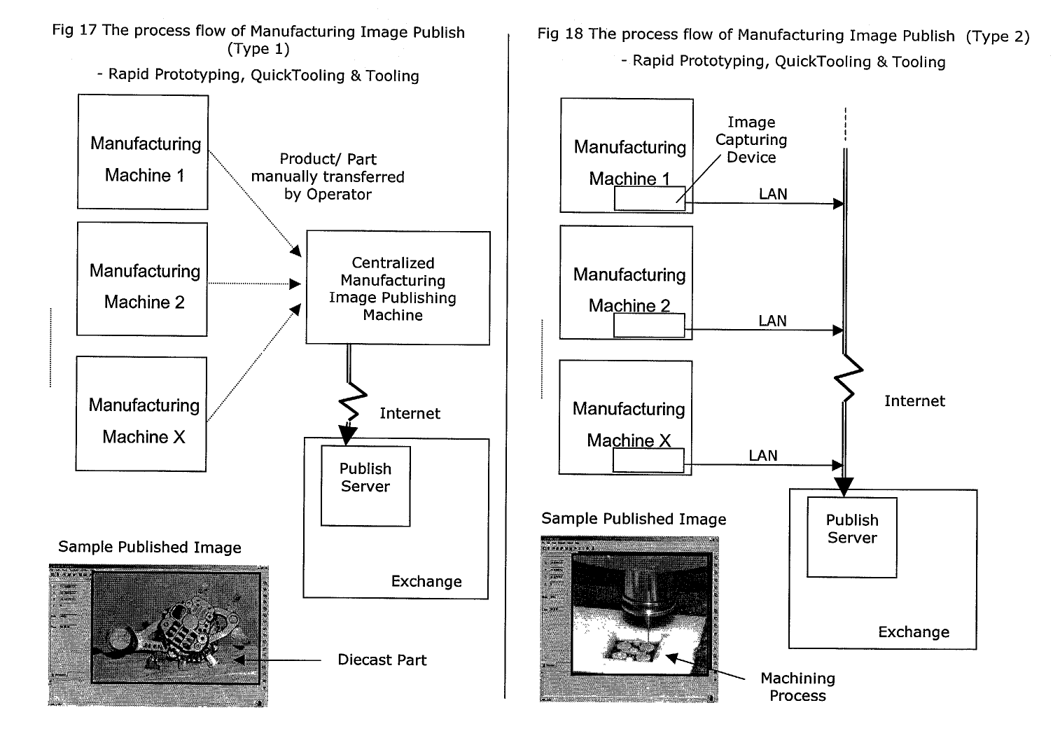

FIGS. 17 and 18 show steps in alternative process flows of the publishing of manufacturing images using a project management processing system suitable for use with the present invention;

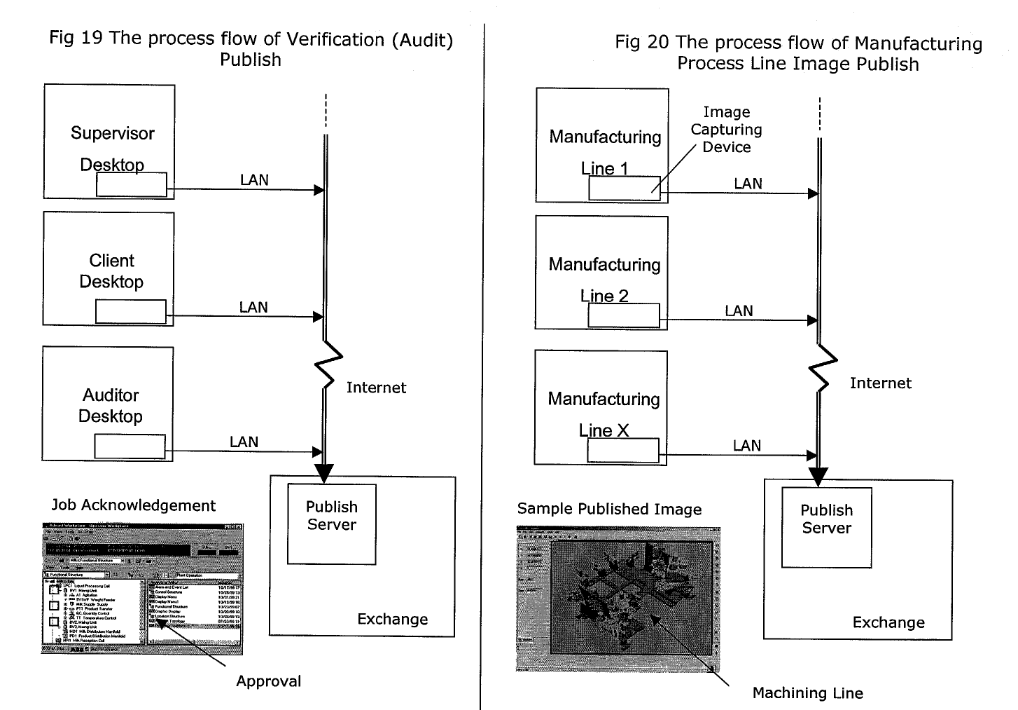

FIG. 19 shows steps in the process flow of the publishing of a verification using a project management processing system suitable for use with the present invention;

FIG. 20 shows steps in the process flow of the publishing of an image of a process line using a project management processing system suitable for use with the present invention;

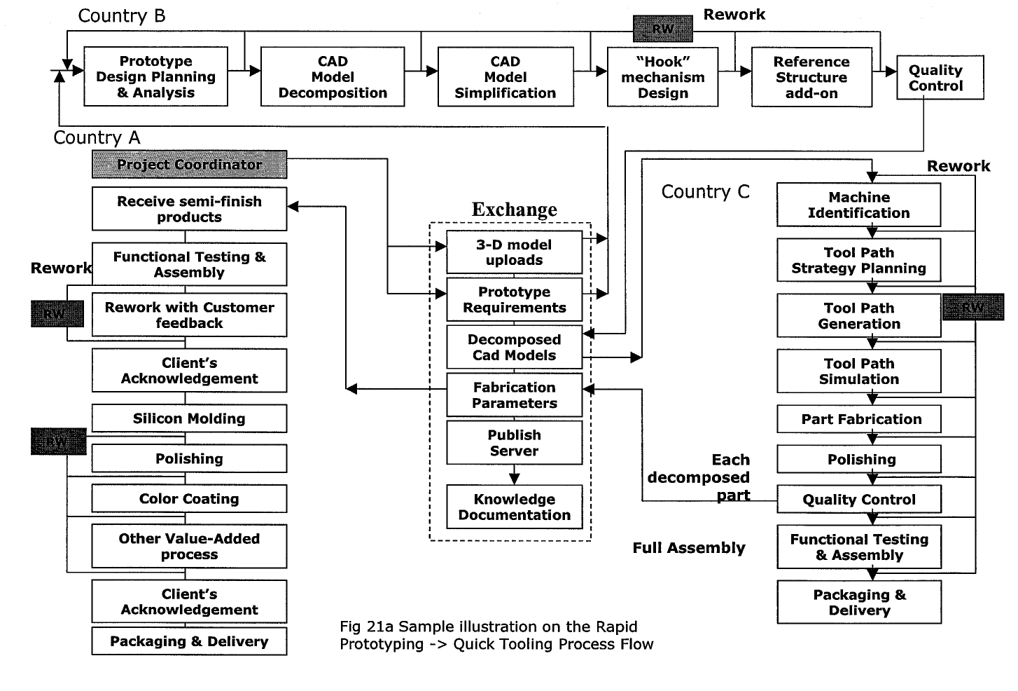

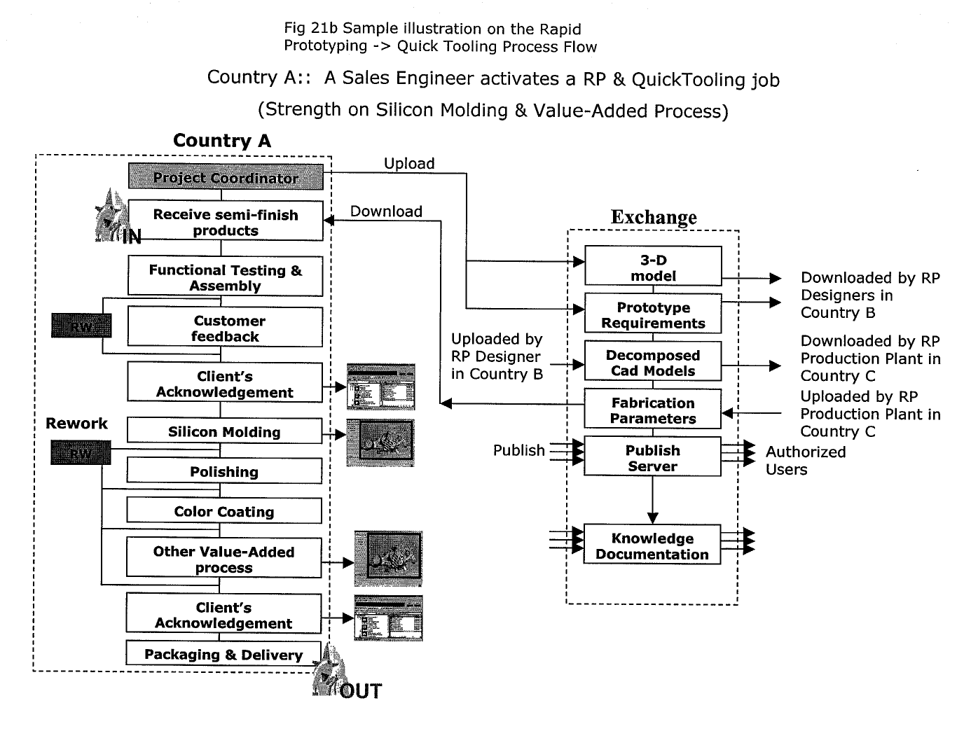

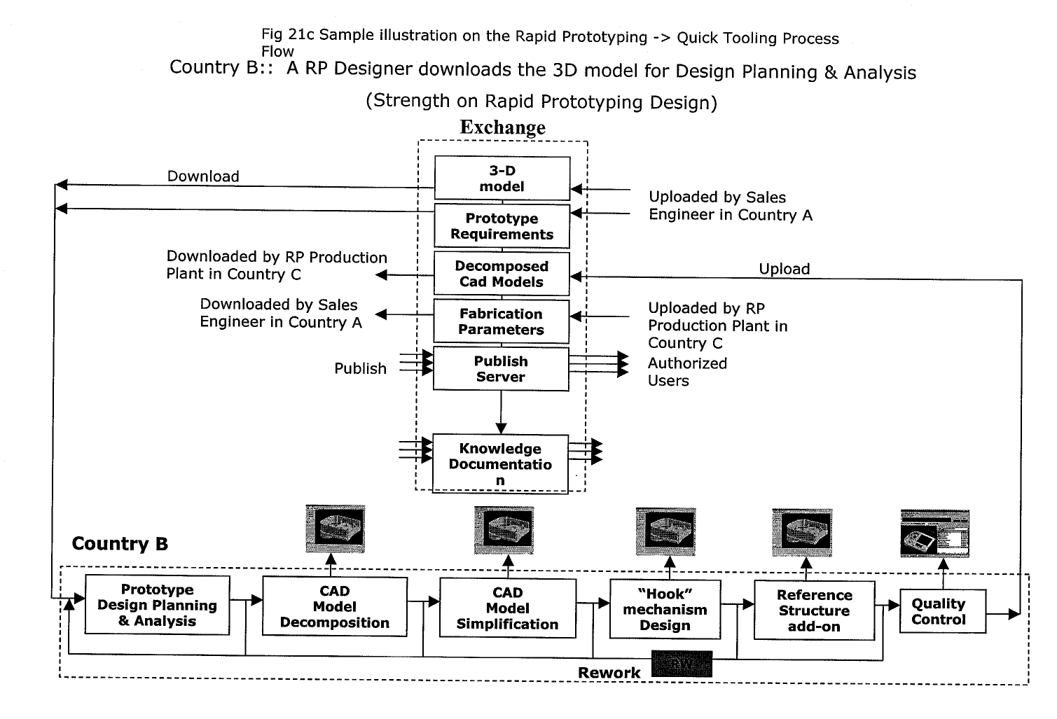

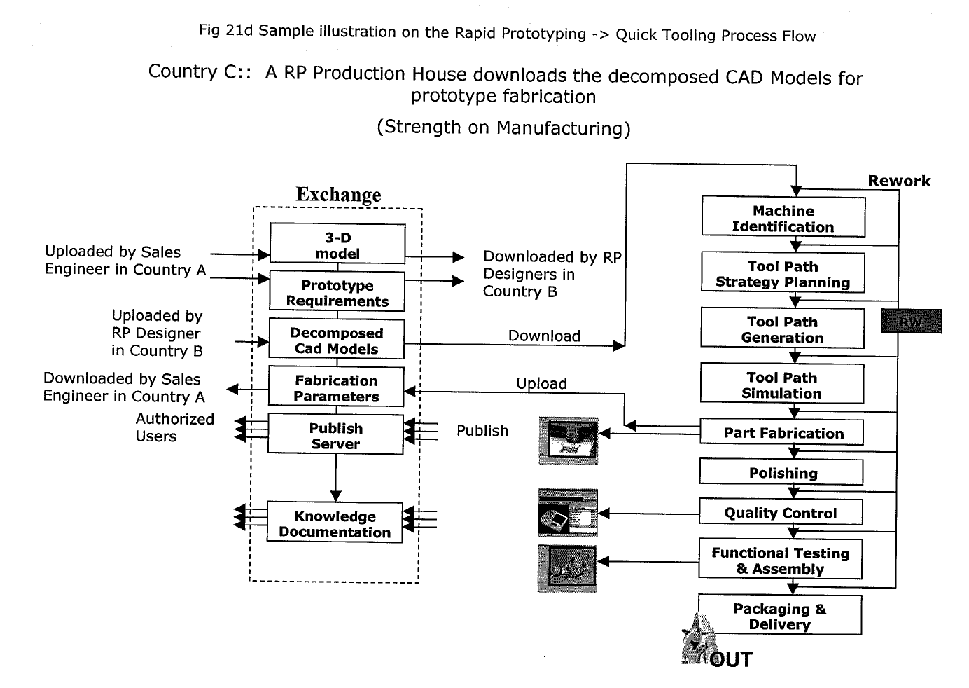

FIGS. 21a, 21b, 21c and 21d show the roles of entities in different countries during a process managed by an exchange management system embodying the present invention.

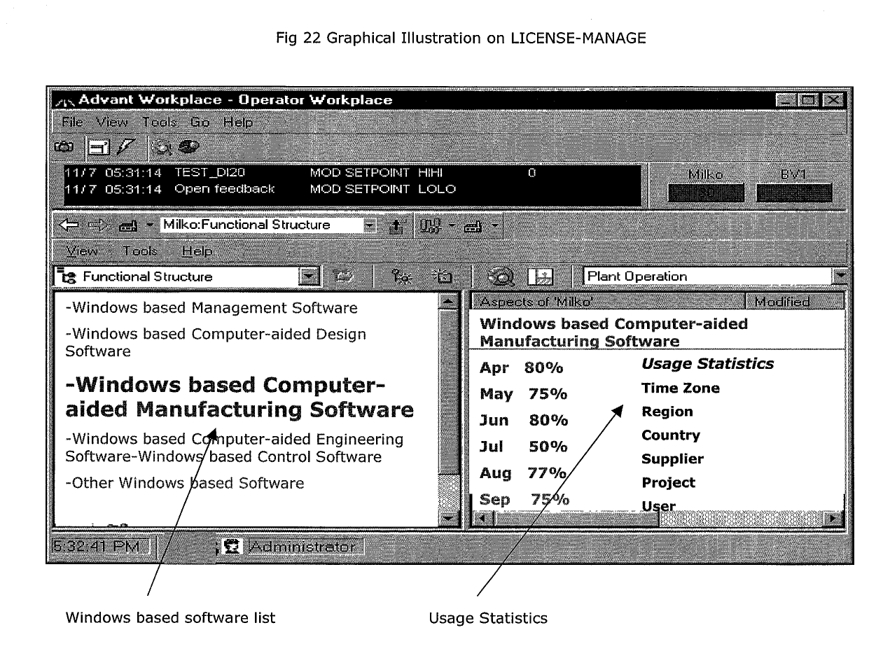

FIG. 22 shows a screen that may be seen when using a resource management processing system suitable for use with the present invention;

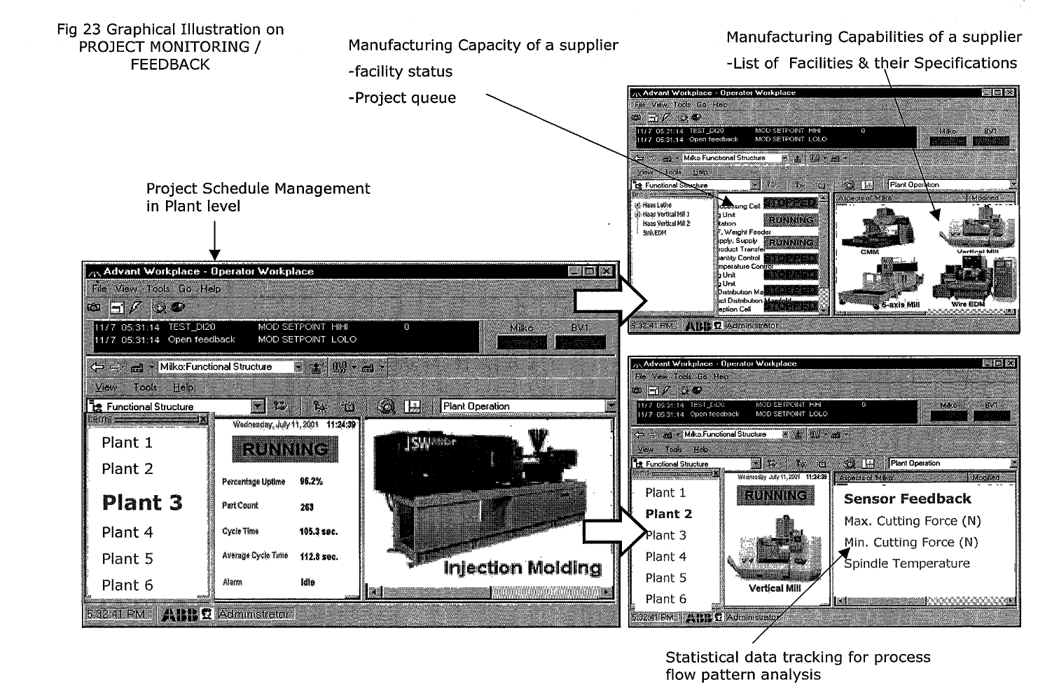

FIG. 23 shows a screen that may be seen when using a monitoring processing system suitable for use with the present invention; and

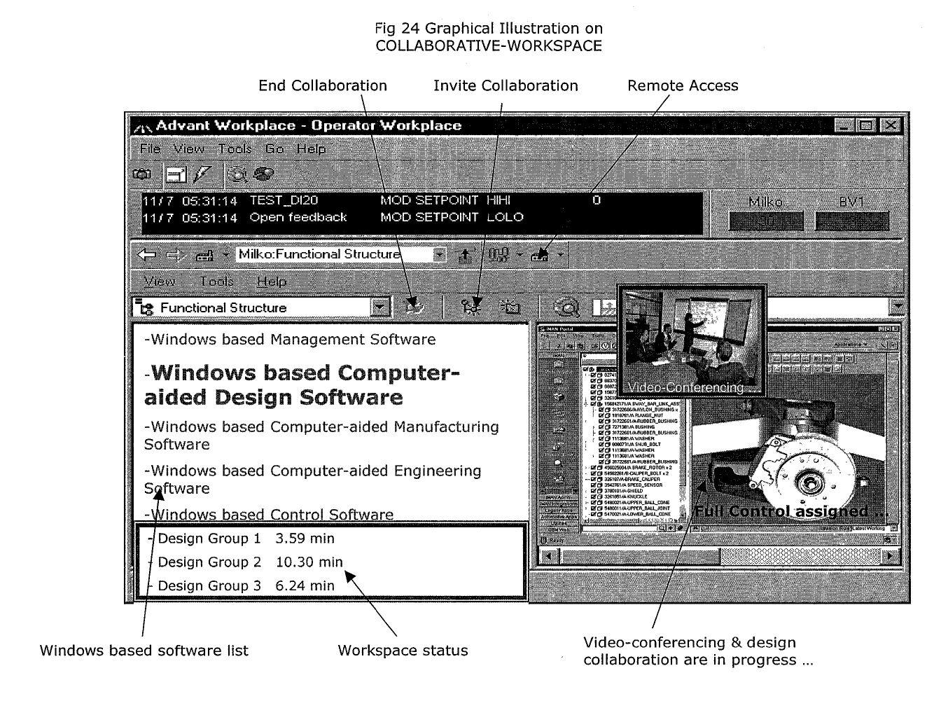

FIG. 24 shows a screen that may be seen when using a collaboration processing system suitable for use with the present invention.

Turning firstly to FIG. 1, a typical conventional B2B exchange is shown. As described above, such an exchange acts as a neutral party, simply to match-make a few suppliers for each potential buyer's project. It commonly considers criteria, such as responsiveness, quality, delivery, cost and so forth. This B2B exchange may further adopt an auction or reserve approach in an attempt to minimise manufacturing costs.

FIG. 2 schematically represents the integration of a consortium-based manufacturing B2B exchange embodying the present invention with customers, suppliers, strategic partners and others. In FIG. 2, components that directly link to the exchange include a management team, an accounts department, auditors, administrators, customers, first tier suppliers and strategic partners. Lower tiers of suppliers are indirectly linked to the B2B exchange through their respective first tier suppliers in related sectors. The management team, accounts department, auditors and administrators are independently linked to the exchange in order to monitor proceedings and ensure smooth business transactions.

Strategic partners connected with the B2B exchange advantageously comprise a bank, an insurance company and a transportation/warehousing representative. The bank provides financing, leasing and hire purchase; the insurance company compulsorily insures all business transactions; and the transportation/warehousing representative provides freight forwarding, shipping and warehousing services.

Customers in the B2B exchange may include solution buyers, end-users, licensees, “pay-as-you-go” members, “flat fee” members, web-based process-lines, system and machines. The term “solution buyers” in the context of the present invention encompasses new or existing product initiators, or dealers (trading houses) for the end-users. Hence, end-users do not have direct links with the exchange. All participants mentioned above, who have direct or indirect links to the exchange, are preferably provided with dedicated desktops for Internet-speed communication, collaboration and commercial transactions with the exchange.

All business transactions conducted through the exchange are handled on-line with the following conditions:

1) The Management team, accounts department, auditors, administrators, first tier suppliers and strategic partners are permitted to have on-line and off-line communications with the B2B exchange, and with customers thereof; and

2) The lower tiers of suppliers are allowed to have on-line and off-line communications with the B2B exchange, but are not permitted to have off-line communication with customers.

On-line communications between lower-tier suppliers and customers may be possible, but will only be permitted if both parties' identities are encrypted, and their communications fully monitored by the exchange.

The B2B exchange categorises multiple tiers of suppliers into several centres, as illustrated in FIG. 3. FIG. 3 depicts the architecture of an exchange management system which is operable to link a total integrated electronic business to a one-stop manufacturing solution. The management system offers a comprehensive solution package to serve manufacturing customer needs. Solution packages for solution buyers or end-users may include: a total manufacturing supply chain from a turnkey centre; industrial design and rapid prototyping; quick tooling and plastic injection moulding; diecasting; special purpose manufacturing; electronic assemblies; purchase of machines; machine retrofitting; and purchase of industrial spare part and machinery components.

Additionally, solution packages for manufacturing software customisation and licensing may be offered to licensees. Solution packages for maintenance and support may be offered to the web-based systems, process lines and machines.

Likewise, solution packages for resource sharing for “pay as you go” members and “flat fee” members include management (supply chain management, enterprise resource planning etc.) software, computer-aided design software, computer-aided engineering software, computer-aided manufacturing software and controller software relating to machines that may be employed in the execution of a manufacturing task carried out through the exchange.

FIG. 4 shows a project management cluster in an exchange embodying the present invention. A project management cluster generally comprises a project manager with a few of the first tier suppliers. The project manager in the present context is the exchange coordinator, who first provides a quote in response to a potential buyer's RFQ, has direct communication with the buyer, and manages the buyer's project from the initial stages until completion of the project.

To initiate a new project, the project manager will first identify a list of first tier suppliers, typically representing different manufacturing or design disciplines. These disciplines may include mechanical, electronic, electrical or industrial design, software, tooling, manufacturing and assembly.

The choice of first tier suppliers made by the project manager will be largely dependent on the business scale, reliability, responsiveness, quality and related technical strengths of the suppliers in question.

Preferably, each first tier supplier is expected to lead and manage at least one second tier supplier. For a relatively large job, a project management cluster might encompass several tiers of suppliers. The suppliers in the project management cluster should have no international border, language or culture barriers. In the project management cluster, the project auditor (or management team) performs random audits on all projects being conducted through the exchange.

FIG. 5 depicts a method and process of distributing RFQ's in the exchange management system. Since the management system may be accessed through the Internet, RFQ's may be expected from anywhere around the globe, and at any time.

All incoming RFQ's are first stored in the exchange management system, and the sending time of each RFQ is converted into GMT. The REQ's are then automatically sorted among project manager clusters according to the time zone in which each project manager is located. The RFQ's are further distributed to project managers in a cluster taking into account considerations such as geographical location, capability and project capacity.

A project manager who is selected to respond to a RFQ will preferably be alerted to the fact that he has been chosen through e-mail (via the Internet) or by a message delivered through a wireless device. In the event of server failure in a particular hub, special instructions or authority will be given by the exchange administrator to project managers from other hubs to specifically assist in the provision of responses to RFQ's which are sent to the hub which has failed.

Referring again to FIG. 5, in order to implement a “round the clock” operation, the exchange management system preferably supports a total of 3 hubs which, as described above, may be NAFTA, European and Asia Pacific hubs. Each hub has a time difference of approximately 8 hours with respect to each of the other hubs. Hence, these hubs should be capable of adequately responding to incoming RFQ's from any part of the world at any time.

The number of hubs in a zone may be increased in proportion to the number of RFQ's received in that zone.

FIG. 6 illustrates the job scope of a project manager and his associated staff in the process of responding to a RFQ. Firstly, a potential buyer or customer submits his registration to the exchange. A user identity and password is issued to the potential buyer, once a verification of the potential buyer's profile has been performed.

To create a REQ, the potential buyer first logs into his buyer desktop. Once he has created a RFQ with an answered questionnaire and any related technical drawings, this completed RFQ can be uploaded to the exchange. The project manager will receive and acknowledge the RFQ. He will then check a material database, a knowledge database and a supplier database, and may subsequently break the job for which an RFQ has been received down into smaller job scopes. A group of first tier suppliers is next identified to provide quotations for the job, or for a relevant smaller job scope, and will be sent appropriate sub-RFQ's relating to the job or to these job scopes.

Upon receiving the sub-RFQ's, the selected first tier suppliers will reply to the project manager accordingly through their supplier desktops, providing the project manager with appropriate quotes. Upon receiving replies from the first tier suppliers, the selected project manager will evaluate the replies, select suppliers to be awarded the job or jobs corresponding to the sub-RFQ's, and prepare an offer to be sent to the potential buyer. Communication via messaging or video-conferencing is only possible between the buyer and the selected project manager, and (if necessary) between the project manager and the supplier. At this stage, it may be expected that such communication will be required to negotiate on price, and to clarify the technical specifications of the potential buyer's specified job.

Next, an official offer is made to the potential buyer and a new job request alert is sent to the exchange account desktop. This new job request alert notifies the accounts department of the exchange that a potential buyer has requested a quotation. The accounts department may be required to take appropriate follow-up action, if this appears to be required.

If the potential buyer accepts the offer, he is required to confirm the terms under which the job will be performed, and to prepare a purchase order. This purchase order will be sent directly via fax to the exchange accounts department who will alert the project manager upon receipt of the offer. Payment and financial arrangements will be handled by the bank and the accounts department. Upon confirmation of payment, the project manager will be alerted to activate the job, thereby initiating the task instructed by the buyer. A new project account will eventually be created in the exchange management system to manage the finances of the project in question.

FIGS. 7a and 7b show modular implementation methods for the exchange management system of the present invention in two alternative process chains.

Turning firstly to FIG. 7a, after a project has been awarded to certain suppliers, a process chain may have a flow from the buyer to the consortium-based B2B exchange to the first tier supplier, a second tier supplier and finally to a third tier supplier. Firewalls (indicated on FIG. 7a by perpendicular lines superimposed over a connecting line) may be implemented between the buyer and the B2B Exchange, and between the B2B Exchange and the first tier supplier.

In addition, since each supplier's relationship with the B2B exchange is individual, certain process information may be strictly retained by a supplier. Hence, a traditional management system will encounter difficulties in providing a link from a buyer down to the manufacturing facilities of; for example, a third tier supplier.

In the present invention, the exchange management system may be customised as a management module, which may be modularly implemented within the intranet of an individual supplier. This management module may provide all or most of the features provided by the exchange management system, but will be implemented rather differently. The exchange management system and the management module will have similar or identical data exchange formats, allowing simple connectivity between the exchange and the supplier's intranet system. However, the individual supplier is able to configure the management module so that only authorised data may be transmitted through this data exchange format between the supplier in question and other parties involved. Hence, using a management module as described above, an individual supplier may enjoy the benefits of rapid and efficient data transfer between itself and the exchange, without compromising the security of any sensitive information.

FIG. 7b depicts the modular implementation of an exchange management system in another process chain. This process chain may have a flow from the buyer through multiple exchanges (labelled as exchanges A, B and C on FIG. 7b), first tier CAD/CAM/CAE suppliers, first tier manufacturing suppliers, exchange integrated CAD/CAM/CAE suppliers, exchange integrated manufacturing systems, and exchange management, accounts, or audit or procurement systems.

In the process depicted in FIG. 7b, exchange A represents the consortium-based B2B exchange, whilst exchanges B and C represent external exchanges, which may have similar capabilities to exchange A, but may be located in different regions for the purpose of meeting customer needs worldwide, or may focus upon different manufacturing applications (for instance, the automotive or precision engineering industry).

To more clearly illustrate the modular implementation of the exchange management system of the present invention, suppliers are generally categorised into two different groups, namely, CAD/CAM/CAE suppliers and manufacturing suppliers.

A CAD/CAM(CAE supplier is a pure software based solution provider and may provide for all CAD, CAM or CAE users throughout the process chain, who create 3-D models, generate tool paths and analyse 3-D models. In contrast, a manufacturing supplier is purely a hands-on based solution provider and may provide for all users who manage or operate the control systems of the manufacturing machine system, manufacturing lines and facilities connected with the exchange.

While the suppliers are sub-divided into two groups, as described above, it is noted that in manufacturing industries, the users of CAM software and controller software, are usually grouped together under one roof.

Integrated systems for CAD/CAM/CAE centres and manufacturing facilities are shown in FIG. 7b. These integrated systems are exchange owned, which allows sharing of most of the process data within exchange A. In contrast, the multiple tiers of supplier will usually implement their own respective dedicated management systems, and this will allow sharing only of limited process data with exchange A.

Exchange management, accounts, audit and procurement systems each have important roles in the managing and smoothing of business transactions within exchange A.

The process chain described above can be smoothly linked by implementing a customised management exchange system in exchanges B and C, as well as a management module in each supplier module, if this appears to be necessary.

All management modules and other exchange management systems may be provided with process/data pipelines for connection to the exchange A, and all process data is shared throughout the process chain in accordance with the level of authorisation of each individual entity involved with the process.

In a preferred embodiment of the present invention the buyer, through the buyer desktop, has access to the exchange management system of the exchange A (indicated by the arrow containing the word “visibility” in FIG. 7b) and ultimately the above-described management system is able to allow the buyer, via wired or wireless methods, to track the progress of his project accurately at each stage, including those stages involving lower tiers of suppliers.

FIG. 8 depicts a manufacturing infrastructure setup for the above-mentioned management module. Major components of the infrastructure setup, which may be linked via an intranet, the Internet or wireless links, preferably include management and storage servers, an administration office, manufacturing facilities, internal maintenance and internal technical systems, and external maintenance and external controller software systems.

The management and storage servers may comprise: a local licenced management server, to manage and track check-in and check-out of all software licences; a local application server, to implement all related application software, a local data management server, to implement management related systems, such as supply chain management systems, enterprise resource planning, and so on; and a local knowledge management server, to manage and store relevant knowledge throughout the product lifecycle.

The above-described administration office advantageously comprises a management system, an accounts system, an audit system and a procurement system.

The manufacturing facilities are divided into multiple levels of authorisation, for instance, machine system or process lines, controllers and local project management desktops.

A manufacturing machine, in the context of the present invention, is a single dedicated machine, such as a vertical milling machine or an electrode discharge machine. In contrast, a manufacturing system in this context refers to a group of manufacturing machines which are selected to perform a customised manufacturing process, for instance, a rapid prototyping process. The term “manufacturing process line” in this context refers to a flexible manufacturing system.

Each of the above-described facilities is controlled by respective controller software, which may be Windows-based (either open-architecture or PC based). Moreover, this software can be managed and supervised by a local project management desktop at a plant level, and at later stages by tie management module.

The internal maintenance and technical systems would respectively provide real-time maintenance and technical support or upgrades in-house to all of the manufacturing facilities involved within the exchange.

The external maintenance systems and controller software systems respectively provide real-time maintenance and upgrades for the hardware and software systems used by members of the exchange. Some of the components in the infrastructure setup depicted in FIG. 8 may be collaborative, remote, real-time monitoring and feedback-enabled to establish communication links and provide a flow of process information throughout the management module. In such real-time monitoring, readings may be captured from a sensing device involved in the manufacturing process and this reading may be automatically communicated to the buyer, under present conditions.

Ultimately, the infrastructure setup of FIG. 8 manages the above-described project management processing communication links and process information to allow the system to offer visual management of the project process. Further, the management module incorporates the above-described resource management processing system to manage and track check-in and check-out of all appropriate management and controller software. The above-described collaborative processing system is further provided, and this allows a collaborative and remote environment through which projects may be executed.

The above-described monitoring processing system is also provided, to allow project schedule (i.e. queue) management, facility operating status information, the maintenance of a database of manufacturing facilities and their respective technical specifications, and statistical data tracking for process flow pattern analysis.

Turning to FIG. 9, a design engineering and manufacturing desktop infrastructure setup for a management module is depicted. The major components of the infrastructure setup, which are linked via an intranet, the Internet, or wireless links in the manufacturing supplier module, include a management modules management and storage service, an administration office, a computer aided design system, manufacturing and engineering centre, internal technical systems and external manufacturing software upgrade systems.

The above-mentioned management and storage servers and the administration office perform the same functions as described in relation to FIG. 8. The computer aided design, manufacturing and engineering centres comprise two levels of authority, namely software systems and a local project management desktop.

The software systems in the supplier module are preferably mechanical design software equipment, and systems engineering software, shape design and styling software, manufacturing software and computer aided analysis software. Each of the software systems can be managed and supervised by a local project management desktop at a client level, and at later stages by the management module.

Again, internal technical systems preferably provide real-time support and upgrades in-house to each of the above software systems. An external maintenance system and a controller system respectively provide real-time maintenance and upgrade for the hardware and software systems.

As described above and in relation to FIG. 8, some of the components in the supplier module are collaborative, remote, real-time monitoring and/or feedback enabled, to establish communication links and provide a flow of process information throughout the supplier module.

In common with the setup described with reference to FIG. 8, the setup of FIG. 9 is provided with the above-described project management, resource management, collaborative and monitoring processing systems, and the functions of these systems within the setup will be readily appreciated

FIG. 10 depicts an infrastructure of a supplier desktop setup for an exchange management system embodying the present invention The major components of the supplier desktop setup, which are preferably linked by the Internet or wireless links to the B2B exchange, include the exchange management system, associated management modules, central management and storage servers, a central administration office, exchange integrated manufacturing facilities, exchange integrated computer-aided design, manufacturing and engineering centres, a central system for controller software upgrade, a central system for maintenance, and a central system for research and development, financial, insurance, warehousing or freight forwarding modules.

The central management and storage servers comprise: a licence management server to manage and track check-in and check-out of all software licences within the exchange; an application server to implement all related application software; a data management server, to implement management related systems, such as supply chain management systems, enterprise resource planning, and so on; a knowledge management server to manage and store knowledge throughout a product lifecycle, and a software server, to store related technical software for downloading purposes.

The central administration office provides the same function as that described above with relation to FIG. 8.

The exchange integrated manufacturing facilities are implemented in a similar fashion to the manufacturing facilities described above, in relation to the management module depicted in FIG. 8, however these facilities are directly accessible within the exchange. Similarly, the exchange integrated computer-aided design, manufacturing and engineering centres are implemented in a similar manner to the corresponding components described above in relation to the management module FIG. 9, however again these centres are directly accessible within the exchange.

Again, each facility or centre may be controlled by respective software, and this software can be managed and supervised by a local project management desktop at a plant level and at later stages by a management module.

The central system for controller software upgrades provides real-time software upgrades, training and consultation within the exchange. The central system for management provides real-time maintenance to all manufacturing facilities associated with the exchange, as well as within the supplier's module. Finally, the central system for research and development performs research and development and receives real-time technical feedback from all software centres and manufacturing facilities within the exchange, as well as within the supplier's module.

In common with the setups described in FIGS. 8 and 9, some of the components in the set up of FIG. 10 may be collaborative, remote, real-time monitoring and feedback enabled to establish communication links and provide a flow of process information throughout the exchange.

Also in common with the setups described with reference to FIGS. 8 and 9, the setup of FIG. 10 is provided with the above-described project management, resource management, collaborative and monitoring processing systems, and the functions of these systems will be readily appreciated.

Turning to FIG. 11, the implementation of the exchange management system of the present invention in an exchange integrated with several existing management systems is shown. These existing management systems may comprise an enterprise resource planning system and a supply chain management system.

As may be seen in FIG. 11, the exchange management system is situated at the “centroid” of a collaborative platform. Integrating existing web-based and supply chain management technologies/engines into the collaborative platform, this system architecture allows all related users to support and access the system at their respective authority levels. Each member is provided with a set of related tools (those shown in Ring 1 on FIG. 11) to allow direct and critical communication, as well as collaboration and commercial transactions within the exchange. In addition, these members share a set of common management tools (those shown in Ring 2 on FIG. 11) within the platform. Users of the exchange may include: customers, exchange integrated manufacturing facilities and software systems; financing, insurance, warehousing and transportation representatives; technical and/or maintenance systems; suppliers; and management, accounts, audit and procurement representatives.

In general, a collaborative environment such as that described above reduces design cycle time, minimises reworking costs, enables innovation and product development and improves procurement efficiency.

Advantageous embodiments of the present invention combine such a collaborative solution with direct commerce opportunities, thereby enabling businesses to design products efficiently and effectively, and to configure, manufacture and market products in the shortest possible time.

FIG. 12 depicts a process flow for a typical product from the design stage through to manufacturing of the product.

Generally, the stages of the process comprise the design of the product, rapid prototyping and quick tooling for the product, engineering, tooling and manufacturing or the setting up of manufacturing process line. However, it will be appreciated that individual projects may have more or fewer than this, depending upon the circumstances of the project. The design stage can further be broken down into industrial design, mechanical design, electrical design and software design stages.

In such a process certain tasks, such as rapid prototyping, quick tooling and engineering (e.g. testing or simulation) can be performed concurrently with one another. In addition, throughout the process, repeated reworking of a particular task is likely to be required, due to, for example, a design change or a machining error.

Usually, there will be an authorised person or persons to acknowledge or perform an audit at the end of each task, so as to provide approval for the execution of subsequent tasks in the process. This process flow can be modularly Implemented in various industries, such as the automotive, consumer electronic, machine tool and precision engineering industries. Additionally, each task can often be ether segmented into sub-tasks, and this is illustrated in FIG. 12.

Implementing a process such as that described above typically involves project engineers from many disciplines, and an efficient process flow generally requires some commonly available system integrations, such as supply chain management, enterprise resource planning, material resource planning and so on. Unfortunately, as discussed above, the efficiency and productivity during such a process is typically rather low, due to the fact the entity performing each task within the process flow is likely to have unique characteristics, such as: the geographical location in which the task takes place; the identity of the entity performing the task; the core competitive advantage (for instance, the manufacturing capabilities) of the entity in question; the industrial application of the entity performing the task (for instance, the industry in which the entity operates); and the culture and government policy prevailing in the location in which the entity resides.

As a result, traditional systems are typically unable to provide an accurate update on the progress of a project. As described above, each individual project engineer is likely to have his or her own interpretation of “project progress” and this makes it extremely difficult for project progress to be accurately quantified, for instance by a buyer. Additionally, throughout a process such as that described above, most of the tasks require quality checks, verification, audits or approval to allow the initiation of subsequent tasks. Again, these steps require the implementation of appropriate quality standards.

In order to alleviate these difficulties, exchange management systems embodying the present invention fundamentally comprise; a project management processing system; a resource management processing system; a monitoring processing system, and a collaboration processing system.

FIG. 13 illustrates these four components, which will now be described in greater detail.

A display generated by a project management processing system for use with the present invention is shown in FIG. 14. Aside from various functions and menus, the progress of a process (for instance, an engineering process) is presented visually to the user. This visual presentation may take the form of an image, preferably a “live” image, of a design which has been created, a product that has been made, or a process-line that is being used to make products.

This system provides several advantages. Firstly, since users are able to view directly the progress of a project, the users will immediately be able to tell if the standard of the project has been compromised, or if an unexpected system or process has been implemented in the supply chain. Also, on a more general basis, it is far easier to determine whether a project is progressing satisfactorily if one is able to view the progress of the project at each stage, rather than relying on progress supports which, as discussed above, are likely to be subjective.

Aside from the ability to allow users to view the progress of a project, the project management processing system preferably includes a publishing tool. This tool allows each stage of the project to be published, and to serve as a checkpoint in the completion or handover of a task from one chain in the project process to the next. Each published stage of a project documents the appropriate point in the lifecycle of the project, and can be retrieved or reviewed at a later date. This system provides benefits for updating and communication between procurement, logistics, marketing and after sales-staff. The types of item which can be published through the publishing tool include 2D drawings, 3-D models, schematic drawings, assembly drawings and so forth.

Additionally, the project management processing system may be equipped with common office tools such as e-mail, a messaging system, a chat room, an RFQ management system, a supplier and buyer database, and so on.

Turning to FIG. 15, the process flow of the publishing of a design is depicted schematically. Design desktops are connected to a publishing server, which comprises a part of the exchange, through a network such as a local area network or the Internet. Once a design job relating to, for example, a 3-D item has been completed through a design desktop, the 3-D model that has been created (which may be in one of, for example, the CATIA, UNIGRAPHICS or PRO-ENGINEER formats), is translated into a light-weight model format showing only surface representation. It will be appreciated that this model format has a relatively small file size. The converted 3-D model is transferred to the publishing server from the design desktop in question.

An authorised user is then allowed to view the 3-D light-weight model using the viewer of the management module, and may additionally perform tasks such as model translation, model rotation, spin, zoom, measurement of the volume or surface area of the model, assembly of the model and so forth. The ability of an authorised user to view the model and to perform these tasks thereon allows the user to obtain quickly a useful indication of the current status of a project, as well as the likely quality of a finished article that is to be produced.

FIG. 16 shows a schematic representation of the process flow of the publishing of an engineering result. Engineering results may be published, for example, as 2-D images, 3-D models, or text.

FIGS. 17 and 18 show two alternative types of process flow for the publishing of a manufacturing image. At a manufacturing facility, an image capture device such as a video camera or a digital camera is employed to capture an image, or images, of the finished product or of the on-going manufacturing process. The images that are recorded are automatically sent to the publishing server via the Internet, or via an alternative network, and are stored in an appropriate project folder on the publishing server.

An operator of a manufacturing facility may elect to transfer the machined part manually to a centralised manufacturing image publishing apparatus (in the case of the process depicted in FIG. 17) or he may install separate image capturing devices associated with each manufacturing machine (in the case of the process depicted in FIG. 18). Which of these systems is adopted is a matter of choice, and may depend upon the manufacturing process in question.

FIG. 19 shows a schematic process flow for verification publishing. In this process, the project manager, the client, a supervisor and an auditor are able to perform acknowledgement or verification of a completed task. In addition, these individuals may indicate their approval of a proposed modification to a task.

FIG. 20 shows a schematic representation of the process flow for the publishing of a manufacturing process line image. The publishing of such an image allows a plant supervisor to quickly assess the operation of the “shop floor” status of a manufacturing process line, as well as allowing a buyer to view the progress of vital stages of a project.

FIG. 21a shows some stages in a rapid prototyping and quick tooling process, elements of which are conducted in separate countries. In the process, project co-ordinator is situated in country A. The project co-ordinator has a particular strength in silicon moulding and value-added processes, such as coating and fine polishing. A rapid-prototyping designer is located in country B, and a rapid-prototyping production house is located in country C.

The three above-mentioned entities use a storage server in the B2B exchange to exchange and update 3-D models, prototype requirements, decomposed CAD models, fabrication parameters and databases of other knowledge. It will be appreciated that, in general, a rapid prototyping or quick tooling project is subject to severe reworking during the life of the project and the ability of subscribers to all exchange embodying the present invention to view visual representations of aspects of the progress of a project greatly facilitates such reworking processes.

In the process illustrated in FIG. 21, a sales engineer initiates a rapid prototyping and quick tooling job. The sales engineer meets a buyer, and uploads the appropriate 3-D models and appropriate prototype requirements to the exchange. These models and prototype requirements are subsequently downloaded by the designers in country B for CAD decomposition. Upon the completion of this CAD decomposition, the designers in country B upload the decomposed CAD model into the exchange server.

Subsequently, the production house (which is located in country C) is prompted to retrieve the decomposed CAD models in order to initiate fabrication of the prototype. Upon completion of the fabrication process, a quality check and an assembly testing check are performed.

Next, the three-dimensional parts of the prototype are delivered to the project co-ordinator in country A, while a set of fabrication parameters are uploaded to the exchange server, in case reworking of the prototype in country A proves to be necessary.

The project co-ordinator will then meet with the buyer to discuss possible reworking, final polishing and, ultimately, the silicon moulding process.

FIGS. 21a, 21b and 21c demonstrate how the project management processing system is used to provide efficient project progress status updates to all parties involved in the process illustrated in FIG. 21a.

Turning to FIG. 22, a screen that may be seen by an entity using the resource management processing system is shown. It will be appreciated that this system provides an efficient licence tracking system which centralises resources and enables the sharing thereof world-wide. Additionally, the resource management processing system may provide exact application software usage statistics, which can be used as a measure of the product efficiency throughout the process chain. Preferably, the resource management system is operable to cancel a licence for an item of software that is held by the exchange, if the application software usage statistics show that the item of software in question is being used very little or not a all.

It should be noted that the resource management processing system purely manages the licences of application software, but not the application software itself. Hence, the volumes of data transferred in use of the system are negligible, when compared to the bulk of data that must be transferred in the upload, for example, 3-D image files.

Through the resource management processing system, certain application software licences may be made available for buyers, and payment therefor may be made on a per-day basis, or on any other basis.

FIG. 23 shows a number of screens that may be seen by an entity using the monitoring processing system. This system allows project managers and other authorised users to gain access to updates regarding the capabilities of design and manufacturing facilities, and may offer updates on project schedule (i.e. queue) management, the facilities and software systems available at certain design and manufacturing capabilities, and may also provide data regarding specific projects, for instance the estimated time of completion of a specific task, or the position of the task in the project queue at a certain facility.

Finally, FIG. 24 shows a screen that may be viewed by an entity employing the collaborative processing system. This system provides a collaborative and/or remote project workspace for users of the exchange around the globe to “virtually” meet, or to exercise remote control over a process. Features of the system preferably include a video-conferencing tool to allow users of the exchange to conduct remote conferences, the provision of remote access to software (for instance CAD, CAE, CAM and controller software) for users of the exchange, and the system may also allow an authorised user to assume control of the desktop of any other user in the exchange, provided that the controlling user has sufficient authority to do so and the entity whose desktop is controlled consents to this.

In summary, a skilled reader will understand that the present invention provides an exchange offering significant advantages over conventional exchanges, and which allows easy and efficient communication between subscribers to the exchange, and ultimately the rapid and efficient performance of quality manufacturing tasks.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

We claim:

1. A network-based exchange management system for implementing a manufacturing task requested by a user of an exchange, the system comprising:
a project management processing system, operable to provide a visual representation of the progress of the task to the user;
a resource management processing system, operable to maintain a record of software which the exchange is licensed to utilise;
a monitoring processing system operable, in real time, to monitor the operational status of at least one manufacturing facility involved in the manufacturing task and obtain feedback thereon; and
a collaboration processing system, operable to allow real-time collaboration between the user and other members of the exchange.

2. An exchange management system according to claim 1, wherein the visual representation of the progress of the task comprises a visual representation of at least one of the group consisting of: a design for a product of the task; a product of the task; a process line involved in the task; a result of a test of a product of the task; and a simulated test of a product of the task.

3. An exchange management system according to claim 1, wherein the visual representation of the design for a product of the task may be in the form of at least one of the group consisting of: a two-dimensional drawing, a three-dimensional model; a schematic drawing; and an assembly drawing.

4. An exchange management system according to claim 1, wherein the project management processing system is operable to provide an indication of the verification of the completion of a step in the task.

5. An exchange management system according to claim 1, wherein the record of software which the exchange is licensed to utilise comprises a record of at least one of the group consisting of: management software; computer-aided design software, computer-aided engineering software; computer-aided manufacturing software; and controller software for a machine involved in the task.

6. An exchange management system according to claim 5, wherein the software which the exchange is licensed to utilise comprises any one of the group consisting of Windows-based, PC-based and open architecture software.

7. An exchange management system according to claim 1, wherein the resource management processing system is operable to maintain a record of levels of use by the exchange of at least some of the software which the exchange is licensed to utilise.

8. An exchange management system according to claim 7, wherein the resource management processing system is operable to retract a licence on behalf of the exchange.

9. An exchange management system according to claim 1, wherein the resource management processing system is operable to provide licences under the software which the exchange is licensed to utilise to users of the exchange.

10. An exchange management system according to claim 1, wherein the monitoring processing system is operable to perform at least one of the group consisting of: monitoring the status of a queue of tasks to be performed at the at least one manufacturing facility; monitoring the operational capacity of the at least one manufacturing facility; monitoring the manufacturing status of the requested task; and obtaining feedback on the manufacturing status of the requested task.

11. An exchange management system according to claim 1, wherein the monitoring processing system is operable to maintain a database of at least one of the group consisting of: the status of queues of tasks to be performed at a plurality of manufacturing facilities; the operational capacities of a plurality of manufacturing facilities; the operational capabilities of a plurality of manufacturing facilities; and past performance of a plurality of manufacturing facilities.

12. An exchange management system according to claim 1, wherein the monitoring processing system is operable to perform statistical data tracking for process flow analysis.

13. An exchange management system according to claim 1, wherein the collaboration processing system is operable to perform at least one of the group consisting of: allowing real-time video conferencing between the user and other members of the exchange; allowing remote access to software which may be used in the implementation of the task; and allowing the user or another entity to exercise control over an aspect of the task.

14. An exchange management system according to claim 13, wherein the software which may be used in the implementation of the task comprises at least one of the group consisting of Windows-based, PC-based and open architecture software.

15. An exchange management system according to claim 1, further comprising analysis processing means for receiving data specifying the manufacturing task from the user and for analysing the data to determine parameters of the manufacturing task.

16. An exchange management system according to claim 15, wherein the parameters include at least one of the group consisting of: a material from which an item is to be made; the dimensions of the item; the function of the item; identification of a component to be included in the item, identification of tools required to produce the item; insurance requirements; warehousing requirements; identification of an existing machine with which the item must operate; details of software that must be created or customised for use with the item; identification of spare parts to be manufactured for use with the item; details of on-line maintenance and support required for the item; identification of software to be used in the production of the item; and which of the manufacturing facilities may be used in production of the item.

17. An exchange management system according to claim 1, further comprising quotation provision processing means for calculating an estimated cost of completing the manufacturing task or an estimated delivery schedule for a product of the task on the basis of parameters of the task.

18. An exchange management system according to claim 1, wherein the exchange is managed between the user specifying the manufacturing task, a plurality of manufacturing facilities, and at least one of the group consisting of: a supplier of materials; a supplier of machinery; a licensor of software; a provider of software; a supplier of spare parts; a supplier of warehousing facilities; a supplier of transport services; a supplier of banking services; and a supplier of insurance services.

19. An exchange management system according to claim 1, wherein at least one of the processing systems is located on a server connected to a network.

20. An exchange management system according to claim 19, wherein the network is the Internet.

21. An exchange management system according to claim 1, wherein the exchange management system is capable of modular implementation, such that the exchange management system may communicate with other modularly implemented exchange management systems.

22. An exchange management system according to claim 21, wherein the exchange management system is operable to communication with other exchange management systems associated with exchanges, suppliers or manufacturing facilities when the exchange management system is implemented modularly.

23. An exchange management system according to claim 1, wherein the project management, resource management, monitoring and collaboration processing means are the same processing means.

24. An exchange comprising a plurality of exchange management systems according to claim 1.

25. An exchange according to claim 24, wherein users of the exchange may communicate with the exchange through at least one of the group consisting of the Internet, a local area network, and a wireless communication device.

26. An exchange according to claim 24, further comprising allocation processing means to allocate manufacturing tasks specified by users associated with each of the exchange management systems to manufacturing facilities associated with others of the exchange management systems.

27. An exchange according to claim 26, wherein the allocation of manufacturing tasks among the manufacturing facilities associated with others of the exchange management systems is based at least in part upon the geographical location of the manufacturing facilities.

28. An exchange according to claim 26, wherein the allocation of manufacturing tasks among the manufacturing facilities associated with others of the exchange management systems is based upon parameters of the manufacturing task.

29. A method of managing an exchange for implementing a manufacturing task requested by a user of the exchange, the method comprising the steps of:
providing a visual representation of the progress of the task to the user;
maintaining a record of software which the exchange is licensed to utilise;
monitoring, in real time, the operational status of at least one manufacturing facility involved in the manufacturing task and obtaining feedback thereon; and
allowing real-time collaboration between the user and other members of the exchange.

30. A method according to claim 29, wherein the step of providing a visual representation of the progress of the task comprises the step of providing a visual representation of at least one of the group consisting of: a design for a product of the task; a product of the task; a process line involved in the task; and a result of a test or a simulated test of a product of the task.

31. A method according to claim 29, wherein the step of providing a visual representation of the progress of the task comprises the step of providing a visual representation in the form of at least one of the group consisting of: a two-dimensional drawing, a three-dimensional model; a schematic drawing; and an assembly drawing.

32. A method according to claim 29, further comprising the step of providing an indication of the verification of the completion of a step in the task.

33. A method according to claim 29, wherein the record of software which the exchange is licensed to utilise comprises a record of at least one of the group consisting of: management software; computer-aided design software, computer-aided engineering software; computer-aided manufacturing software; and controller software for a machine involved in the task.

34. A method according to claim 33, wherein the software which the exchange is licensed to utilise comprises at least one of the group consisting of Windows-based, PC-based and open architecture software.

35. A method according to claim 29, further comprising the step of maintaining a record of levels of use by the exchange of at least some of the software which the exchange is licensed to utilise.

36. A method according to claim 35, further comprising the step of retracting a licence on behalf of the exchange.

37. A method according to claim 29, further comprising the step of providing licences under the software which the exchange is licensed to utilise to users of the exchange.

38. A method according to claim 29, further comprising the step of at least one of the group consisting of: monitoring the status of a queue of tasks to be performed at the at least one manufacturing facility, monitoring the operational capacity of the at least one manufacturing facility; monitoring the manufacturing status of the requested task; and obtaining feedback on the manufacturing status of the requested task.

39. A method according to claim 29, further comprising the step of maintaining a database of at least one of the group consisting of: the status of queues of tasks to be performed at a plurality of manufacturing facilities; the operational capacities of a plurality of manufacturing facilities; the operational capabilities of a plurality of manufacturing facilities; and past performance of a plurality of manufacturing facilities.

40. A method according to claim 29, further comprising the step of performing statistical data tracking for process flow analysis.

41. A method according to claim 29, further comprising the step of at least one of the group consisting of: allowing real-time video conferencing between the user and other members of the exchange; allowing remote access to software which may be used in the implementation of the task; and allowing the user or another entity to exercise control over an aspect of the task.

42. A method according to claim 41, wherein the software which may be used in the implementation of the task comprises at least one of the group consisting of Windows-based, PC-based or open architecture software.

43. A method according to claim 29, further comprising the steps of: receiving data specifying the manufacturing task from the user; and analysing the data to determine parameters of the manufacturing task.

44. A method according to claim 43, wherein the parameters include at least one of the group consisting of: a material from which an item is to be made; the dimensions of the item; the function of the item; identification of a component to be included in the item, identification of tools required to produce the item; insurance requirements; warehousing requirements; identification of an existing machine with which the item must operate; details of software that must be created or customised for use with the item; identification of spare parts to be manufactured for use with the item; details of on-line maintenance and support required for the item; identification of software to be used in the production of the item; and which of the manufacturing facilities may be used in production of the item.

45. A method according to claim 29, further comprising the step of calculating an estimated cost of completing the manufacturing task or an estimated delivery schedule for a product of the task on the basis of parameters of the task.

46. A method according to claim 29, comprising managing the exchange managed between the user specifying the manufacturing task, a plurality of manufacturing facilities, and at least one of the group consisting of: a supplier of materials; a supplier of machinery; a licensor of software; a provider of software; a supplier of spare parts; a supplier of warehousing facilities; a supplier of transport services; a supplier of banking services; and a supplier of insurance services.

47. A computer program operable to carry out all of the steps of claim 29 when said program is run on a computer.

48. A computer program according to claim 47, embodied on a server connected to a network.

49. A computer program according to claim 48, wherein the network is the Internet.

50. A computer program according to claim 47, embodied on a computer-readablc medium.
